(19) United States
(12) Patent Application Publication
(10) Pub. No.: US 2014/0030644 A1
(43) Pub. Date: Jan. 30, 2014

(54) IMAGE BEARING MEMBER AND IMAGE FORMING APPARATUS

(71) Applicants: Kunio HASEGAWA, Kanagawa (JP); Hiroshi NAKAI, Kanagawa (JP); Takuya SEKINE, Kanagawa (JP); Kenji KOMITO, Kanagawa (JP)

(72) Inventors: Kunio HASEGAWA, Kanagawa (JP); Hiroshi NAKAI, Kanagawa (JP); Takuya SEKINE, Kanagawa (JP); Kenji KOMITO, Kanagawa (JP)

(73) Assignee: RICOH COMPANY, LTD., Tokyo (JP)

(21) Appl. No.: 13/941,712

(22) Filed: Jul. 15, 2013

(30) Foreign Application Priority Data
Jul. 27, 2012 (JP) 2012-167120

(51) Int. Cl. G03G 15/00; G03G 21/00

(52) U.S. Cl. CPC G03G 5/05
USPC 430/56; 399/159; 430/66; 399/346

(57) ABSTRACT

An image bearing member includes a substrate, a photosensitive layer overlying the substrate; and a surface layer overlying the photosensitive layer, wherein the surface layer includes a cross-linked layer formed by curing a radical polymerizable monomer having no charge transport structure and a radical polymerizable compound having a charge transport structure, wherein a protective agent is supplied to the surface layer by a protective agent supplying member which is arranged facing the surface layer and includes a roller having a core material and a foam layer thereon to form a protective layer on the surface layer.

### CROSS-REFERENCE TO RELATED APPLICATIONS

This patent application is based on and claims priority pursuant to 35 U.S.C. §119 to Japanese Patent Application No. 2012-167120, filed on Jul. 27, 2012, in the Japan Patent Office, the entire disclosure of which is hereby incorporated by reference herein.

### BACKGROUND

1. Technical Field

The present invention relates to an image bearing member and an image forming apparatus.

2. Background Art

In an image forming apparatus employing electrophotography, conventionally a latent electrostatic image formed on a photoreceptor serving as an image bearing member is rendered visible with toner and a thus-formed toner image is transferred to a recording medium such as recording paper and fixed thereon upon application of heat and pressure to obtain a photocopying image.

Image forming employing electrophotography is classified by the method of charging toner particles to output visible images into two, which are: a two-component development system of triboelectrically-charging toner particles and toner carrier particles by stirring and mixing; and a single-component development system of charging toner particles without toner carrier particles.

Since the single-component development system is superior to the two-component development system with regard to space-saving and cost, the single-component development system is widely adopted in a compact printer or facsimile machine.

Image forming apparatuses employing electrophotography typically possesses a belt or drum image bearing member irrespective of the development system.

While such an image bearing member is rotated, it is firstly charged and then exposed to a pattern of activating electromagnetic radiation, such as beams of light, to form a latent electrostatic image on the surface of the image bearing member.

The latent electrostatic image is rendered visible by a development device followed by transfer thereof to a recording medium.

Toner compositions that have not been transferred onto the transfer medium remain on the image bearing member after the visible image transfer.

If these toner remnants are transferred and subject to charging, the image bearing member may not be uniformly charged. To avoid this, conventionally the surface of the image bearing member is cleared of such remnants by cleaning after the image transfer to make the surface clean and ready for charging.

Additionally, both a contact charging system and a proximity charging system have come into widespread use in the charging step to form images reflecting the demand for a compact inexpensive machine.

However, an AC superimposing charging system is adopted in most cases in which an alternate current (AC) component is superimposed on a direct current (DC) component. Otherwise, uniform charging is difficult due to non-uniform contact between a charger and the surface of an image bearing member in the contact charging system or a gap variance therebetween in the proximity charging system.

The proximity charging system utilizing the AC-component superimposition is significantly advantageous in manufacturing a compact machine and improving the quality of print. Additionally, since the charging member and the image bearing member are designed to be not in contact with each other while maintaining uniform charging, the deterioration of the charging member is suppressed.

However, when it comes to a case in which the image bearing member is an organic photoconductor (OPC), it is found that the energy of the AC superimposition charging severs resin chains of the surface of the image bearing member and degrades the mechanical robustness thereof, which accelerates the abrasion of the image bearing member markedly.

Moreover, the AC superimposition charging activates the surface of the image bearing member, thereby increasing the attachability of the surface of the image bearing member and the toner, which is disadvantageous in terms of cleanability.

On the other hand, with the advance of the colorization of output images, smaller and spherical toner particles have been developed to improve and stabilize the image quality. This creates an issue about cleaning.

That is, to remove such smaller and spherical toner particles by cleaning, it is necessary to increase the friction force of a cleaning member against an image bearing member, which results in rapid abrasion of the image bearing member and the cleaning member.

Consequently, each process in the image forming employing electrophotography is under an electric stress or a physical stress.

Accordingly, the surface of an image bearing member that undergoes such stresses changes over time.

As one way to approach this issue, applying a protective agent to the image bearing member is known.

For example, JP-S51-22380-B discloses a method of applying a protective agent having a block form (so-called protective agent block) mainly composed of zinc stearate to an image bearing member. JP-2006-350240-A discloses a method of applying to an image bearing member a protective agent block in which boron nitride is added to the main component of zinc stearate.

Due to the application of the protective agent block to the surface of an image bearing member, the friction index of the image bearing member lowers, thereby suppressing the degradation of a cleaning blade and the image bearing member. At the same time, materials such as un-transferred toner attached to the image bearing member easily detach, thereby improving the cleaning performance and preventing occurrence of filming over time.

There are documents disclosing application of a protective agent block to an image bearing member, including JP-2007-65100-A that discloses a protective layer forming device having a protective agent block, a protective agent supplying member formed of a rotating member having a brush-like form to apply a protective agent attached thereto by contacting the protective agent block to the image bearing member, and a protective agent pressure member to press the protective agent block to contact the protective agent supplying member.

However, a large amount of powder of the protective agent abraded from the protective agent block by the rotating member having a block-like form scatters in the air and is consumed wastefully.

In addition, the brush fiber falls or deteriorates with time, which leads to unstable consumption and supply of the protective agent over a long period of time.

In an attempt to solve this problem, JP-2009-150986-A discloses usage of a protective agent supplying roller having a foam layer.

No or little amount of the protective agent scatters in this attempt.

However, since this foam layer is made of closed pores, the foam layer deteriorates and breaks down with time due to the friction against the protective agent block and the image bearing member.

As a result, supplying the protective agent sufficiently to the image bearing member over an extended period of time is difficult, thereby causing filming on the image bearing member over time.

Among efforts to solve this problem, for example, JP-2012-058539-A discloses a foam roller having a foam layer made of interconnected cells.

Polyurethane foam, typically forming a foam layer of such a foam roller, is formed by capturing carbon dioxide produced during reaction of mixing polyol, polyisocyanate, water, a catalyst, and a foam stabilizer in a polyurethane resin. In manufacturing the polyurethane foam, using a foam stabilizer is indispensable.

The foam stabilizer is to uniformly disperse polyurethane material components having no compatibility with each other to lower the surface tension of the system, thereby facilitating forming stable and uniform foams.

Typically, silicone foam stabilizers such as organo polysiloxane and modified silicone oil are used in such a manufacturing method.

However, polyurethane foam manufactured by using such a foam stabilizer contains low molecular weight siloxane remaining in production. This low molecular weight siloxane bleeds from the foam or is gasified, which causes contamination of peripheral members.

Also, after the foam is assembled into an image forming apparatus, the surface of the image bearing member in the vicinity of polyurethane foam is hydrolyzed. As a result, defective images having white spots corresponding to the contaminated portion are produced. In particular, contamination of the surface of the image bearing member worsens significantly in a high temperature and humid environment.

To solve this problem, JP-2000-313730-A discloses limiting the content of low molecular weight siloxane having 10 or less silicon atoms to 5,000 ppm or less.

Moreover, JP-2007-145904 discloses using polyurethane forming materials containing a silicone foam stabilizer having a hydroxyl group in its molecule structure.

However, the foam disclosed in JP-2000-313730-A mentioned above from which low molecular weight siloxane is removed increases the manufacturing cost, which is disadvantageous in terms of using inexpensive electrophotographic parts.

In addition, in JP-2007-145904-A mentioned above, bleeding of low molecular weight siloxane is not completely stopped, so that the possibility of producing defective images is still not low.

### SUMMARY

The present invention provides an image bearing member that includes a substrate, a photosensitive layer overlying the substrate, and a surface layer overlying the photosensitive layer, wherein the surface layer includes a cross-linked layer formed by curing a radical polymerizable monomer having no charge transport structure and a radical polymerizable compound having a charge transport structure, wherein a protective agent is supplied to the surface layer by a protective agent supplying member which is arranged facing the surface layer and includes a roller having a core material and a foam layer thereon to form a protective layer on the surface layer.

As another aspect of the present invention, an image forming apparatus is provided which includes an image bearing member to bear a toner image, which has a surface layer having a cross-linked layer formed by curing a radical polymerizable monomer having no charge transport structure and a radical polymerizable compound having a charge transport structure and a protective agent supplying member to apply or attach a protective agent to the surface layer of the image bearing member, which includes a roller having a core material and a foam layer thereon.

### BRIEF DESCRIPTION OF THE DRAWINGS

Various other objects, features and attendant advantages of the present invention will be more fully appreciated as the same become better understood from the detailed description when considered in connection with the accompanying drawings, in which like reference characters designate like corresponding parts throughout and wherein

FIG. 1 is a diagram illustrating an example of an image forming apparatus using an image bearing member according to an embodiment of the present disclosure;

FIG. 2 is a diagram illustrating an example of the structure of a protective layer forming device to an image bearing member according to an embodiment of the present disclosure;

FIGS. 3A and 3B are diagrams illustrating the structure and feature related to the foam in a protective agent supplying member for use in the protective layer forming device illustrated in FIG. 2;

FIGS. 4A and 4B are diagrams illustrating the structure of a protective agent supplying member of FIG. 3 for use in the protective layer forming device; and

FIGS. 5A, 5B, 5C, and 5D are diagrams illustrating an example of the molding method and the structure of a protective agent for use in the protective layer forming device illustrated in FIG. 2.

### DETAILED DESCRIPTION

Next, embodiments of the present disclosure are described with reference to accompanying drawings.

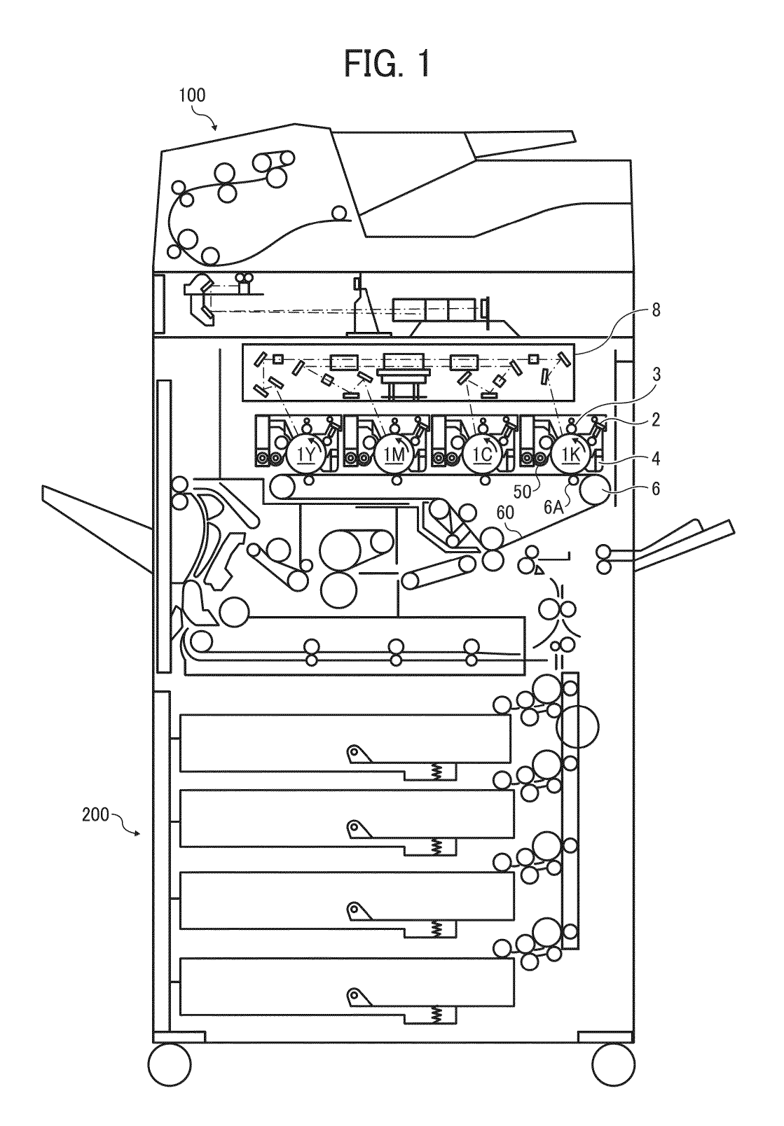

FIG. 1 is a schematic diagram illustrating an embodiment of the image forming apparatus according to an embodiment of the present disclosure.

An image forming apparatus 100 illustrated in FIG. 1 is a color printer employing a tandem system having multiple image forming stations capable of producing different color images, which are arranged along the stretched surface of an intermediate transfer element 60 serving as a transfer device.

The image forming apparatus 100 includes drum image bearing members 1Y, 1M. 1C, and 1K around which protective layer forming devices 2, chargers 3, latent image forming devices 8, development devices 50, transfer devices 6, and cleaners 4 are correspondingly arranged to form images by the following operation.

A series of the image forming processes are described using a negative-positive process.

The image bearing member, typically an organic photoconductor (OPC) having an organic photoconductive layer is discharged by a discharging lamp and uniformly charged with a negative polarity by the charger 3 having a charging member.

When the drum image bearing members 1Y, 1M, 1C, and 1K are charged, a bias applicator applies a charging bias having a DC voltage or a voltage in which an AC voltage is superimposed on the DC voltage to the charging member such that the drum image bearing members 1Y, 1M, 1C, and 1K are charged to a desired voltage.

Latent images are formed on charged drum image bearing members 1Y, 1M, 1C, and 1K by laser beams emitted from the latent image forming device 8 including, for example, a laser beam system. The absolute voltage at an irradiated portion is lower than the absolute voltage at a non-irradiated portion.

The laser beams are emitted from a semiconductor laser and reach the surfaces of the drum image bearing members 1Y, 1M, 1C, and 1K via a polygon mirror having a polygonal column that is rotating at a high speed to scan the surfaces in the rotation axial directions of the drum image bearing members 1Y, 1M, 1C, and 1K.

The thus-formed latent image is developed by toner particles or a mixture of toner particles and toner carrier particles supplied onto a development sleeve 50A serving as a development agent bearing member included in the development device 50 to form a visible toner image. The reference numerals 50B and 50C represent stirring transfer members.

When the latent image is developed, the bias applicator applies a suitable voltage between the bias of the irradiated portions and the bias of the non-irradiated portions of the drum image bearing members 1Y, 1M, 1C, and 1K or a development bias in which an AC voltage is superimposed on the suitable voltage to the development sleeves.

The toner images formed on the drum image bearing members 1Y, 1M, 1C, and 1K corresponding to each color are transferred to the intermediate transfer element 60 by the transfer device 6 and furthermore transferred to a recording medium such as paper fed from a paper feeding mechanism 200.

A voltage having a polarity reversed to that of the toner charging is preferably applied to the transfer device 6 as a transfer bias. Thereafter, a transfer image is obtained by separating the intermediate transfer element 60 from the drum image bearing members 1Y, 1 M, 1C, and 1K.

In addition, the toner particles remaining on the drum image bearing members 1Y, 1 M, 1C, and 1K are retrieved into a toner collection chamber by the cleaning member of the cleaner 4.

A plurality of the development devices described above are accommodated in the image forming apparatus 100 and multiple toner images having different colors sequentially formed by the multiple development devices are sequentially transferred to a transfer material (recording medium). Thereafter, the transferred toner image is conveyed to the fixing mechanism which fixes toner with heat, etc. Alternatively, the multiple toner images are sequentially transferred to an intermediate transfer belt and thereafter transferred to a transfer material such as paper once followed by fixing as described above.

In addition, the chargers 3 are preferably provided in contact with or in the vicinity of each of the surfaces of the drum image bearing members 1Y, 1M, 1C, and 1K and use a discharging wire. Due to this, the amount of ozone produced during charging is significantly reduced in comparison with a corona discharger such as corotron or scorotron.

The image bearing member for use in the image forming apparatus 100 illustrated in FIG. 1 is designed to have a protective layer on its surface.

The protective layer prevents changes of the state of the surface caused by electric stress and mechanical stress applied in each operation of the image forming.

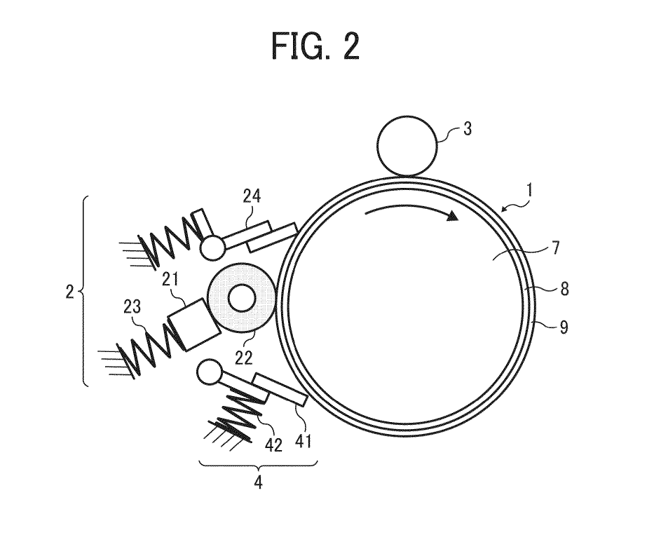

FIG. 2 is a diagram illustrating the structure of a protective layer forming device that forms a protective layer on the surface of an image bearing member.

In FIG. 2, a protective layer forming device 2 in FIG. 2 is arranged facing a drum photoreceptor 1 serving as an image bearing member. The photoreceptor 1 includes a substrate 7, a photosensitive layer 8, and a surface layer 9.

The protective layer forming device 2 includes a protective agent 21 containing a lubricant made of a hydrophobized inorganic compound, a protective agent supplying member 22, a pressing mechanism 23, and a protective layer forming mechanism 24.

In the configuration illustrated in FIG. 2, since the suitable friction state is different between a mechanism removing remnants on the surface of an image bearing member and a mechanism forming a protective layer in some cases, it is preferable to provide a cleaning mechanism 4 having a cleaning member 41, a cleaning pressure mechanism 42, etc. arranged upstream from the protective agent supplying member 22 relative to the image forming process to separate the features.

In FIG. 21, the protective agent 21 is made to contact the protective agent supplying member 22 having a foam by a pressure applied from the pressing mechanism 23.

The protective agent supplying member 22 is arranged downstream from the protective layer forming device 4 serving as a cleaning mechanism as well relative to the rotation direction, i.e., the moving direction of the drum photoreceptor 1 serving as an image bearing member and rotates while contacting the drum photoreceptor 1.

During this rotation, the protective agent 21, e.g., a hydrophobic organic compound which is held on the surface of the protective agent supplying member 22 is supplied to the surface of the drum photoreceptor 1.

The protective layer of the protective agent supplied to the surface of the drum photoreceptor 1 by the protective agent supplying member 22 is regulated by the protective layer forming mechanism 24.

The protective agent supplying member 22 includes at least a core material (core metal) and a foam layer having multiple cell foams which is formed on the outer surface of the core material and other optional devices.

The protective agent supplying member 22 scrapes off the protective agent 21 and supplies it to the surface of the drum photoreceptor 1.

There is no specific limit to the form of the protective agent supplying member. A protective agent supplying member having a roller-like form is preferable.

Next, each member is described.

### Core Material

There is no specific limit to the material, the form, the size, and the structure of the core material.

Specific examples of the material for the core material include, but are not limited to, resin such as epoxy resin and phenolic resin; and metals such as iron, aluminum, and stainless steel.

As the form of the core material, a cylinder-like form is suitable.

### Foam Layer

The foam layer is formed on the outer surface of the core material and has multiple foams (also referred to as cell, hole, or gap).

There is no specific limit to the form of the foam layer. A cylinder-like form is suitable.

There is no specific limit to the material of the foam layer. A specific example thereof is polyurethane foam.

### Polyurethane Foam

There is no specific limit to polyurethane foam. For example, polyurethane foam is suitably used which is manufactured by mixing and reacting polyol, polyisocyanate, a catalyst, a foaming agent, and other optional components such as a foam stabilizer.

### Polyol

There is no specific limit to polyol. For example, polyether polyol and polyester polyol are suitably used. In particular, polyether polyol is preferable in terms of workability and easiness of controlling the hardness of a foam layer.

For example, polyether polyol can be obtained by ring-opening addition polymerization of at least one of ethylene oxide and propylene oxide using at least one of a low molecular weight polyol having 2 to 8 active hydrogen group and a low molecular weight polyamine as an initiator.

In addition, as the polyether polyol, for example, polyether polyol, polyester polyol, and polycarbonate for use in manufacturing flexible polyurethane foam are usable.

In particular, polyether polyether polyol in which ethylene oxide is bonded at the end in an amount of 5 mol % or more is preferable in terms of molding properties.

For example, suitable polyester polyols are obtained by polymerizing dibasic acid or anhydrides thereof such as adipic acid, phthalic anhydride isophthalic acid, terephthalic acid, and maleic anhydride with, for example, glycol or triol such as ethylene glycol, diethylene glycol, triethylene glycol, propylene glycol, diproopylene glycol, 1,4-butane diol, glycerin, and trimethylol propane.

In addition, it is also possible to use a product obtained by depolymerizing a waste material of a polyethylene terephthalate resin with the glycol specified above.

These polyols can be used alone or in combination.

### Polyisocyanate

There is no specific limit to polyisocyanate mentioned above and any known polyisocyanate can be used. Specific examples thereof include, but are not limited to, 2,4-trilene diisocyanate (2,4-TDI), 2,6-trilene diisocyanate (2,6-TDI), tridiisocyanate (TODI), naphtylene diisocyanate (NDI), xylylene diisocyanate (XDI), 4,4′-diphenyl methane diisocyanate (MDI), carbodiimide modified MDI, polymethylene polyphenyl polyisocyanate, and polymeric polyisocyanate. These can be used alone or in combination.

There is no specific limit to the blending amount of polyisocyanate. For example, a suitable range of the equivalent ratio (NCO/OH) of the isocyanate group of the polyisocyanate mentioned above to the hydroxyl group of the polyol mentioned above is from 1.0 to 3.0.

### Catalyst

There is no specific limit to the selection of the catalyst. Any known catalyst used for urethanification reaction is selectable. For example, amine-based catalysts and organic metal-based catalysts are usable.

Specific examples of the amine-based catalysts include, but are not limited to, triethylene diamine, dimethyl ethanol amine, and bis(dimethylamino)ethyl ether.

Specific examples of the organic metal-based catalysts include, but are not limited to, dioctyl tin and distearyl tin dibutylate.

Also, a reactive catalyst such as dimethyl amino ethanol having an active hydrogen is suitable.

These can be used alone or in combination.

There is no specific limit to the blending amount of the catalyst. For example, the content thereof is from 0.01 parts by weight to 20 parts by weight to 100 parts by weight of polyol mentioned above.

Cell wall width, aperture cell diameter, hardness, draft quantity, etc. of the foam layer can be controlled by selecting the kind and controlling the quantity of the catalyst.

### Foaming Agent

There is no specific limit to the selection of the foaming agent. Specific examples thereof include, but are not limited to, water, fluorocarbon-based compounds, and hydrocarbon-based compounds having a low boiling point. These can be used alone or in combination.

Specific examples of the fluorocarbon-based compounds include, but are not limited to, HCFC-141b, HFC-134a, HFC-245fa, and HFC-365mfc.

Specific examples of the hydrocarbon-based compounds having a low boiling point include, but are not limited to, cyclopentane, n-pentane, iso-pentane, and n-butane.

There is no specific limit to the blending amount of the foaming agent. For example, the content thereof is from 5 parts by weight to 50 parts by weight to 100 parts by weight of polyol mentioned above.

The cell wall width, aperture cell diameter, hardness, draft quantity, etc. of the polyurethane foam layer can be controlled by the selection and the quantity of the foaming agent.

### Other Components

There is no specific limit to the blending amount of the other components. Optionally, foam stabilizers, cross-linkers, foam breakers, electroconductive agents, anti-static agents, flame retardants, viscosity reduction agents, pigments, stabilizers, colorants, anti-aging agents, ultraviolet absorbents, and anti-oxidants. These can be used alone or in combination.

There is no specific limit to the foam stabilizer mentioned above. For example, silicone surfactants are suitable.

Products of silicon surfactants available from the market are usable.

Specific examples thereof include, but are not limited to, dimethyl siloxane foam stabilizers (e.g., SRX-253, manufactured by Dow Corning Toray Silicone Co., Ltd. and F-122, manufactured by Shin-Etsu Chemical Co., Ltd.) and polyether modified dimethyl siloxane-based foam stabilizers (e.g., L-5309- and SZ-1311, manufactured by Nippon Unicar Company Limited). These can be used alone or in combination.

There is no specific limit to the blending amount of the foam stabilizer. For example, the content thereof is from 0.2 parts by weight to 10 parts by weight to 100 parts by weight of polyol mentioned above.

The cross-linkers and the foam breakers are blended to control the closed pore properties and the interconnected cell properties of foams in the foam layers.

There is no specific limit to the cross-linkers. Specific examples thereof include, but are not limited to, triethanol amine and dietanol amine

There is no specific limit to the foam breakers mentioned above. For example, foam breakers having a high foam breaking properties are suitable.

There is no specific limit to the blending amount of the cross-linkers and the foam breakers.

Normally, the components except for polyisocyanate are preliminarily mixed and admixed with the polyisocyanate component just before molding.

There is no specific limit to the structure of the foam layers. For example, there are a closed pore type, an interconnected cell type, and a mixing type thereof.

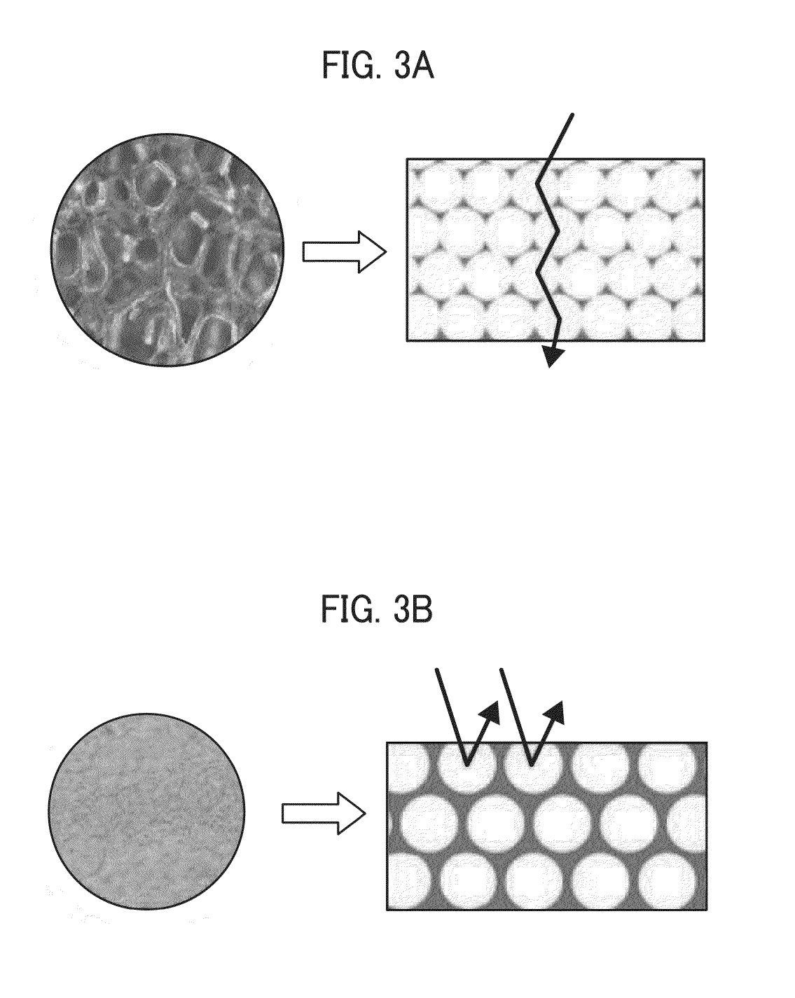

FIG. 3 is a diagram illustrating the structure and function of the foam layer. FIG. 3A is a diagram illustrating the interconnected cell type and FIG. 3B is a diagram illustrating the closed pore type.

In the foam layer of the interconnected cell type illustrated in FIG. 3A, the foams adjacent each other are connected so that air and water pass through the foam layer.

In the foam layer of the closed pore type illustrated in FIG. 3B, the foams are independent so that air and water do not pass through the foam layer.

Of the two, the interconnected cell type is preferable because it has a small compressive residual strain and easily returns to the original form even after compressed so that the interconnected cell type is not easily deformed over an extended period of use.

In addition, powder of a protective agent does not easily scatter by friction in the interconnected cell type in comparison with the closed pore type.

Also, the interconnected cell type is capable of sufficiently and uniformly protecting an image bearing member by supplying and scraping a small amount of the protective agent, thereby preventing occurrence of filming on the image bearing member.

Moreover, a small protective agent block will suffice, which is advantageous in terms of size reduction of a machine.

There is no specific limit to the density of the foam layer mentioned above but a range of from 20 g/cm³ to 150 g/cm³ is preferable because the outer diameter of a roller does not change with time.

The density of the foam layer mentioned above is obtained by measuring the weight and the apparent volume of a manufactured sample cube having a dimension of about 30 cm for the width, the length, and the height according to JIS K7222.

There is no specific limit to the average foam diameter of the foam layer. It is preferably from 100 μm to 1,200 μm.

The average foam diameter of the foam layer can be measured by using a laser microscope (VK 9500, manufactured by KEYENCE CORPORATION).

There is no specific limit to the number of cells per inch of the foam layer. It is preferably from 40 cells/inch to 100 cells/inch.

When the number of cells is too small, the protective agent is not efficiently applied even if the image bearing member and the protective agent supplying member have a large linear speed difference.

When the number of cells is too large, the hardness of the foam layer tends to increase. When the image bearing member and the protective agent supplying member have a linear speed difference with great hardness, the drive torques for both increase.

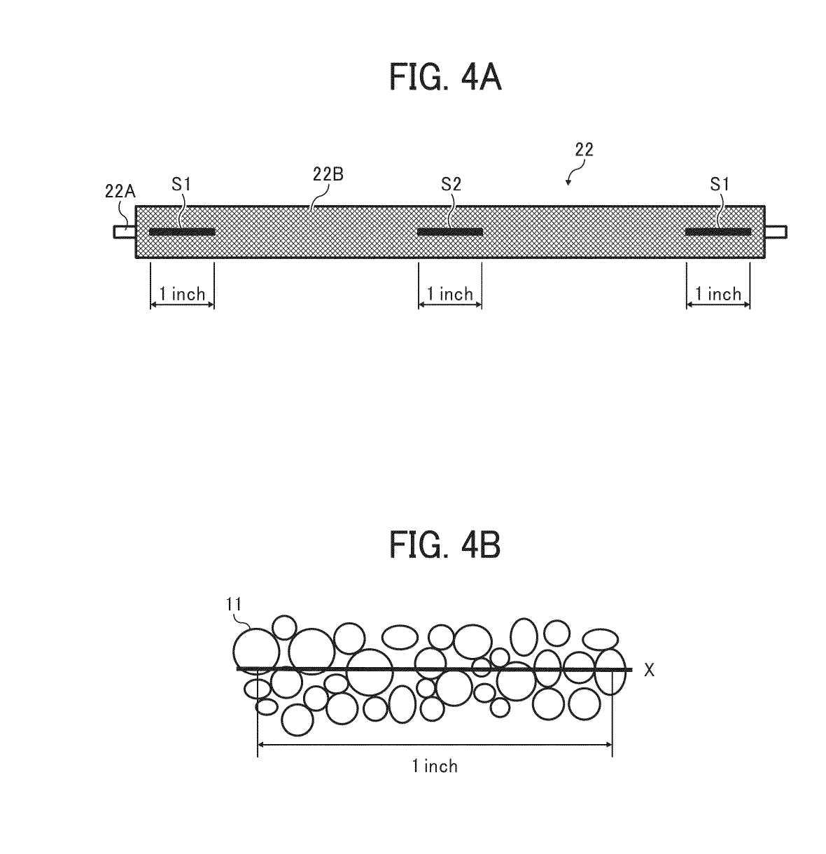

The number of cells per inch of the foam layer can be measured, for example, in the direction as illustrated in FIGS. 4A and 4B.

FIG. 4A is a side view of an example of the protective agent supplying member 22 having a foam layer 22B on the outer periphery of the core material 22A.

FIG. 4B is an enlarged schematic view illustrating an example of the exposed surface of the foam layer 22B of the interconnected cell type in which multiple adjacent foams are connected to each other. 1 inch is 25.4 mm in this description.

As illustrated in FIG. 4A, in the surface of the foam layer 22B, three points are arbitrarily selected at both ends and the center in the axial direction of the protective agent supplying member 22.

In FIG. 4A, a reference numeral S1 represents the measured points at both ends and, a reference numeral S2, at the center.

Next, two more measured points are selected along the circumference direction of the foam layer 22B for each measured point (S1 and S2), which makes 9 measured points in total.

Then, using a microscope, photo images at respective measured points are observed by a microscope (e.g., digital microscope VHX-100, manufactured by KEYENCE CORPORATION).

As described in FIG. 4B, draw a line X corresponding to the length of 1 inch (25.4 mm) at the center of the photo image and count the number of cells 11 on the line X followed by calculating the average thereof, which is determined as the number of cells (cells/inch).

The cell 11 present on the line X includes a cell through which the line X pierces and a cell which contacts the line X how slight it may. Any of such cells is counted as one cell.

For example, in FIG. 4B, the number of the cells is 12/inch.

“1 inch” when used to measure the number of cells is “1 inch” in the axial direction as illustrated in the measuring points (S1 and S2) of FIG. 4A because it is calculated from a 2-D photo image in the measuring method described above. As described in the manufacturing method of the protective agent supplying member described later, since the protective agent supplying member is formed by cutting part of a preliminarily prepared foam and winding the part around the core material, the number of the cells per inch in the axial direction of the protective agent supplying member substantially matches the number of the cells per inch in the circumference direction of the protective agent supplying member.

There is no specific limit to the thickness of the foam. The thickness thereof can be determined and preferably ranges from 1 mm to 4 mm.

When the average thickness is too small, the impact of the shaft (core material) tends to become large. When the average thickness is too large, the scraped amount of the protective agent tends to lessen.

When the foam layer is cylindrical, the distance between the inner peripheral and the outer peripheral is defined as the thickness. The average thickness is the average of arbitrarily selected and measured three points with regard to the thickness of the foam layer.

There is no specific limit to the hardness of the foam layer. The hardness preferably ranges from 10 N to 430 N.

The hardness of a foam layer is the average of values measured at arbitrarily selected three points on the surface of the foam layer based on JIS K 6400.

The form of the cell (interconnected cell type or pore cell type), the number of cells, and the hardness of the foam layer can be controlled by the kind of raw materials of polyurethane foam, the amount of foaming agent, and reaction condition when manufacturing the foam layer.

There is no specific limit to the manufacturing method of the protective agent supplying member 22.

A manufacturing example is as follows when the polyurethane foam mentioned above is used as the material for the foam layer.

First, materials of polyurethane foam are foamed and cured by a known method to form polyurethane foam having a block-like form. The thus-obtained polyurethane foam is cut to a desired form and the surface is polished followed by processing to obtain a cylindrical foam having cells open to the surface. Thereafter, the core material mentioned above is inserted into the cylindrical foam.

Next, using a grinder and a cutting machine, the grinding blade, etc, is brought into contact with the polyurethane foam in rotation, the blade is moved in parallel with the direction of the axial direction of the protective agent supplying member to cut the polyurethane foam to a predetermined thickness (traverse grinding).

Consequently, a cylindrical protective agent supplying member having cells open to the surface is obtained.

Moreover, by changing the rotation speed and the moving speed of the protective agent supplying member, it is possible to form concavo-convex portions irregularly on the surface of the foam layer.

An adhesive is optionally applied to the core material to improve the attachability between the foam layer and the core material. Through these processes, the protective agent supplying member is manufactured.

Another manufacturing method of the protective agent supplying member is as follows.

Polyurethane foam materials are poured into a mold for molding the protective agent supplying member containing the core material for foaming and curing.

By this molding, the protective agent supplying member is manufactured.

Among these methods, it is preferable to use a mold in terms that the foam layer and the surface having openings are formed simultaneously and the processing precision is good.

Since the manufacturing method using a mold obviates the need for complicated processing and is capable of forming the foam layer having suitable openings to the surface, it is preferable to provide a releasing layer of a fluorine resin coating agent, a releasing agent, or the like to the inside surface of the mold.

Next, the protective agent 21 for the image bearing member is described. The protective agent 21 contains at least an aliphatic acid metal salt and an inorganic lubricant and may optionally contain other components.

These are as follows:

### Aliphatic Acid Metal Salt

There is no specific limit to the aliphatic acid metal salt. Specific examples thereof include, but are not limited to, stearic acid metal salts, oleic acid metal salts, paltimic acid metal salts, caprylic acid metal salts, linolenic acid metal salts, and ricinolic acid metal salts.

These can be used alone or in combination.

Specific examples of the stearic acid metal salts include, but are not limited to, barium stearate, lead stearate, iron stearate, nickel stearate, cobalt stearate, copper stearate, strontium stearate, calcium stearate, cadmium stearate, magnesium stearate, and zinc stearate.

Specific examples of the oleic acid metal salts include, but are not limited to, zinc oleate, magnesium oleate, iron oleate, cobalt oleate, copper oleate, lead oleate, and manganese oleate.

Specific examples of the palmitic acid metal salts include, but are not limited to, zinc palmitate, cobalt palmitate, zinc palmitate, magnesium palmitate, aluminum palmitate, and calcium palmitate.

A specific example of the caprylic acid metal salt is lead caprylate.

Specific examples of the linolenic acid metal salts include, but are not limited to, zinc linolenate, cobalt linolenate, and calcium linolenate.

Specific examples of the ricinoli acid metal salts include, but are not limited to, zinc ricinoleate and cadmium ricinoleate.

Among these, materials having lamella crystal is preferable because it has amphipathic property molecules self-organized laminar structure and the crystal is broken and slides along the interlayer upon application of a shearing force, meaning that it has excellent lubricity. Stearic acid metal salts are preferable in terms that it relatively uniformly covers the surface of an image bearing member, thereby preventing the image bearing member from electric stress in the charging process and reducing contamination of the image bearing member and zinc stearate is preferable in particular.

There is no specific limit to the amount of the aliphatic acid metal salt in the protective agent.

### Inorganic Lubricant

There is no specific limit to the inorganic lubricant.

Specific examples thereof include, but are not limited to, mica, boron nitride, molybdenum disulfide, tungsten disulfide, talc, kaolin, montmorillonite, calcium fluoride, and graphite. These can be used alone or in combination. Among these, boron nitride, mica, and talc are preferable and boron nitride is more preferable because it is excellent about subduing the contamination of a charging member.

There is no specific limit to the amount of the inorganic lubricant in the protective agent.

There is no specific limit to the ratio of the aliphatic acid metal salt to the inorganic lubricant in the protective agent. The ratio of the aliphatic acid metal salt:the inorganic lubricant in mass ratio preferably ranges from 100:0 to 50:50 and more preferably from 90:10 to 60:40.

When the ratio of the aliphatic acid metal salt is too small, it tends to be difficult to form a protective layer on the image bearing member. When the ratio is within the preferable range, the contamination of the image bearing member and the charging member is subdued good.

There is no specific limit to the size and form of the protective agent. As to the form, a bar form such as quadrangular prismform or a cylindrical form is suitable.

Among these, a quadrangular prism form is preferable.

### Molding Method

There is no specific limit to the molding method of the protective agent. For example, a melt-molding method and a compression molding are suitable. In general, the protective agent formed by the melt-molding is translucent and the protective agent formed by the compression molding is white, so that these are distinguishable by naked eyes.

Among these, the compression molding is preferable as the method of manufacturing a protective agent.

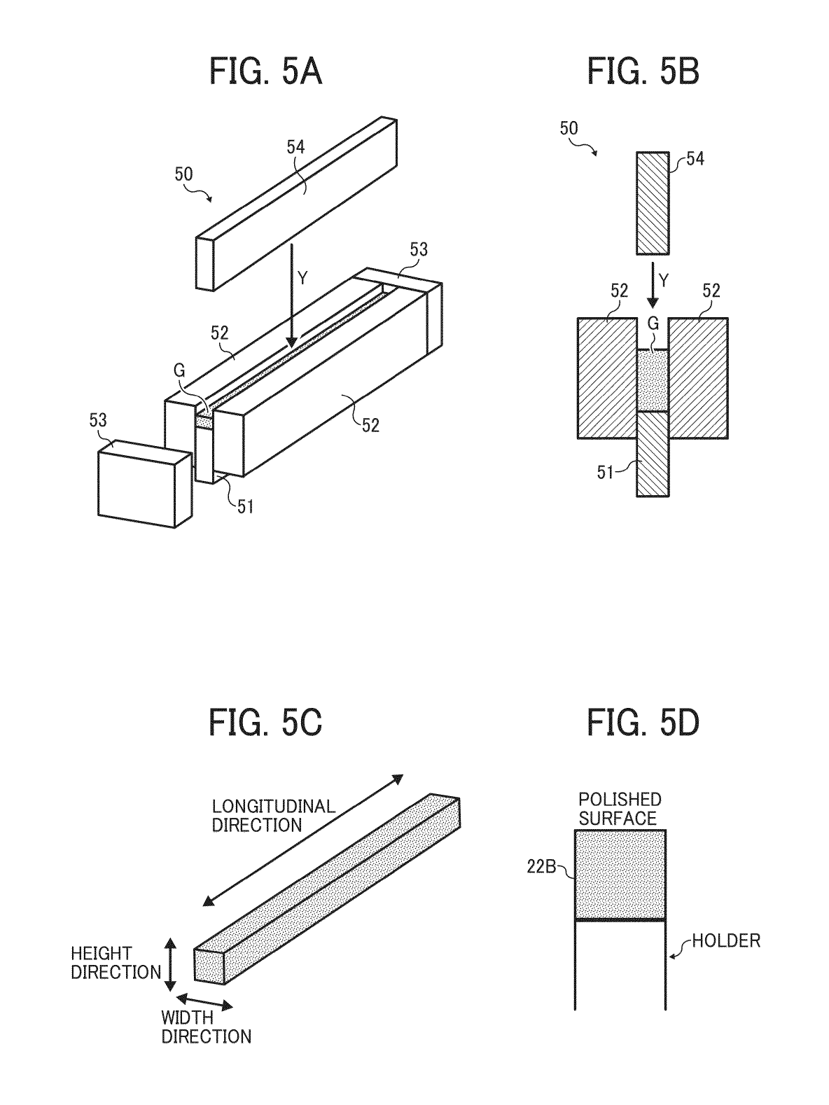

An example of the method of the compression molding is described with reference to FIGS. 5A, 5B, 5C, and 5D.

FIGS. 5A, 5B, 5C, and 5D are diagrams illustrating an example of the manufacturing device of the protective agent. FIGS. 5A and 5B are schematic cross-section illustrating the manufacturing device.

As illustrated in FIGS. 5A and 5B, a manufacturing device 50 of the protective agent includes a lower cast 51, a pair of side casts 52 that is arranged to sandwich the lower cast 51 along the side planes extending in the longitudinal direction of the protective agent, a pair of end casts 53 that is arranged to sandwich the side casts 52 and forms the end planes of the protective agent relative to the longitudinal direction of thereof, and an upper cast 54.

In FIG. 5A, one of the end casts 53 is disassembled for illustration but actually occupies the position facing the other of the end casts 53. When compression-molding the protective agent, these end casts 53, the lower cast 51, and the side casts 52 form a closed space except for the space where the upper cast 54 advances.

In addition, in FIGS. 5A and 5B, when the upper cast 54 advances into the closed space along the direction indicated by an arrow Y, the end casts 53, the lower cast 51, the side casts 52, and the upper cast 54 form a complete closed space.

The space in which the upper cast 54 is removed is filled with a powder G, which is a raw material of the protective agent. The powder G is particle, granule, or a mixture thereof.

When completing filling the space with the powder G, the upper cast 54 is advanced into the closed space along the direction Y to form the complete closed space, the powder G is pressed to form a block of the protective agent.

By these processes, a protective agent block having a quadrangular prism-like form is manufactured by compressing molding as illustrated in FIG. 5C.

The protective agent is used with the reverse side of the polished surface attached to a holder as illustrated in FIG. 5D.

The pressing mechanism 23, and the protective layer forming mechanism 24, and the protective layer forming mechanism 41 illustrated in FIG. 2 possibly have the following configuration.

### Pressing Mechanism 23

Any member that presses the protective agent 21 for the image bearing member to contact the protective agent 21 with the protective agent supplying member 22 can be used as the pressing mechanism 23. For example, an elastic element such as a pressing spring is suitable.

### Protective Layer Forming Mechanisms 24 and 41

Any mechanism that forms a protective layer by regulating the protective agent 21 supplied to the surface of the image bearing member is usable as the protective layer forming mechanism. For example, a blade is suitable.

There is no specific limit to the material for the blade. Specific examples thereof include, but are not limited to, urethane rubber, hydrin rubber, silicone rubber, and fluorine-containing rubber. These can be used alone or in combination.

These blades can be subject to coating or impregnating the contact point with the image bearing member using a material having a low friction coefficient. In addition, fillers such as organic fillers and inorganic fillers can be dispersed in the blade to adjust the hardness thereof.

These blades are fastened to a blade support by an arbitrary method using, for example, adhesion or attachment such that the front end of the blade is brought into contact with and pressed against the surface of the image bearing member. The thickness of the blade is not necessarily unambiguously regulated taking into account the balance between the thickness and the pressure but is preferably from 0.5 mm to 5 mm and more preferably from 1 mm to 3 mm

In addition, the length, i.e., free length, of the blade which flexibly protrudes from the support is also not necessarily unambiguously regulated taking into account the balance between the free length of and the pressure but is preferably from 1 mm to 15 mm and more preferably from 2 mm to 10 mm

As described above, the protective layer forming mechanism is to secure the protection of the surface of an image bearing member by regulating the protective agent attached to the surface of the image bearing member but the protective agent tends to change its composition.

For this reason, if a block or clump of the protective agent is directly pressed against the surface of an image bearing member to form a protective layer, the protective agent is excessively supplied and the efficiency of forming a protective layer worsens.

Furthermore, the protective layer is multi-layered, thereby inhibiting the transmission of light in the irradiation conducted while forming a latent electrostatic image. This leads to limit of the selection of the kind of the protective agent.

Therefore, by providing a protective layer forming member between the protective agent and the image forming apparatus, the protective agent is possibly provided uniformly to the surface of the image bearing member even when a soft protective agent is used.

Another structure of the protective agent layer forming member is obtained by forming a covering layer of resin, rubber, elastomer, etc. on the surface of an elastic metal blade such as a spring board by coating, dipping, etc., via a coupling agent or a primer component, if desired, and optionally, thermally cured. The formed layer can be subject to surface grinding treatment, if desired.

The covering layer includes a binder resin and a filing agent with optional components.

There is no specific limit to the binder resin and any resin can be suitably selected. Specific examples thereof include, but are not limited to, fluorine resins such as perfluoroalkoxy alkane (PFA), polytetrafluoroethylene (PTFE), FEP, a copolymer of tetrafluoroethylene.hexafluoropropylene (FEP), and polychlorinated vinylidne (PVdF), fluorine rubber, and silicone-based elastomers such as methylphenyl silicone elastomers.

There is no specific limit to the thickness of the elastic metal blade. It preferably ranges from 0.05 mm to 3 mm and more preferably from 0.1 mm to 1 mm.

The elastic metal blade can be subject to treatment such as bending work to cause the blade significantly parallel to the spindle after assembly to prevent distortion of the blade.

A pressure that extends a protective layer to form a protective layer is sufficient as the pressure from the protection layer forming member to the image bearing member. As the linear pressure, it is preferably from 5 gf/cm to 80 gf/cm and more preferably from 10 gf/cm to 60 gf/cm.

In addition, the protective layer forming member can be served as a cleaning member. However, to form a protective layer more securely, it is preferable to preliminarily remove remnants including toner on the image bearing member by a cleaning member to prevent the residual from mingling into the protective layer.

Next, the image bearing member is described.

The image bearing member (photoreceptor) of the embodiment has a layer structure having a cross-linked surface layer formed by curing a radical polymerizable monomer having no charge transport structure and a radical polymerizable compound having a charge transport structure.

The advantages are as follows:

Firstly, it is desired that the surface layer of the photoreceptor is cured by heating or exposure to light and insoluble in an organic solvent. The photoreceptor is durable to mechanical stress over an extended period of time and has a markedly-improved durability to damage and excellent cleanability.

As curable resins, thermoset resins, optically curing resins, and electron curing resins are suitable. In particular, ultraviolet curing resins have a high hardness and durability.

Specific examples thereof include, but are not limited to, urethane resins, acrylic resins, epoxy resins, and silicone resins.

In addition, to satisfy the electrostatic properties of a photoreceptor, charge transport power is imparted to the surface layer.

Without the charge transport power, the residual voltage rises and the sensitivity deteriorates, thereby degrading the stability of the image quality of the photoreceptor.

To meet these conditions, as described above, the photoreceptor of the embodiment has a cross-liked structure formed by curing a radical polymerizable monomer having no charge transport structure and a radical polymerizable compound having a charge transport structure, which leads to stabilization of the electrostatic properties and prevention of degradation or changes of the surface layer.

If the surface layer contains a low molecular weight charge transport material having no functional group, the low molecular weight charge transport material precipitates or white turbidity is produced due to its low incompatibility, thereby degrading the mechanical strength of the surface layer, increasing the residual voltage, degrading the sensitivity, extremely increasing the surface roughness, which leads to production of defective images. In terms of this, to impart the charge transport power to the surface layer, it is preferable to use a radical polymerizable compound having a charge transport power and a functional group and cure it with a radical polymerizable monomer.

In this embodiment, the radical polymerizable compound having a charge transport structure with two or more functional groups are usable unless it has an adverse impact on the smoothness and electrostatic properties and durability.

Although it is possible to increase the cross-linking density by containing a radical polymerizable compound having a charge transport structure with two or more functional groups, bulky hole transport compounds are linked and entangled in many bondings, thereby distorting the surface layer and causing the curing reaction to proceed non-uniformly.

As a result, the resilience to the external stress deteriorates locally, causing a large variation of the abrasion resistance.

For this reason, concavo-convex portions occur locally, which has an adverse impact.

Conclusively, using a radical polymerizable compound having a charge transport structure with a functional group is preferable to a radical polymerizable compound having a charge transport structure with two or more functional groups.

As the radical polymerizable monomer having no charge transport structure to be cured with the radical polymerizable compound having a charge transport power, it is possible to use a radical polymerizable monomer having one or two functional groups but the density of the cross-linking bonding in the surface layer becomes thin, which is a negative impact on drastic improvement of the durability to damage.

In the present disclosure, it is more preferable to use a radical polymerizable monomer having three or more functional groups in the surface layer. This tends to develop a three dimensional network structure, thereby increasing the degree of cross-linking and the elastic displacement ratio, which makes it easy to strike a balance between the elastic displacement ratio and the hardness.

That is, a radical polymerizable monomer having multi-functional groups for curing increases not only the abrasion resistance of a photoreceptor to mechanical stress but also the durability to damage.

Therefore, in the present disclosure, a surface layer formed by curing a radical polymerizable monomer having three or more functional groups with no charge transport structure and a radical polymerizable compound having a functional group with a charge transport structure is most preferable, thereby achieving excellent abrasion resistance and cleanability, which leads to excellent durability.

The composition materials of the liquid application of the surface layer for the image bearing member for use in an image forming apparatus related to the embodiments of the present disclosure are described next.

The radical polymerizable monomer having three or more functional groups without a charge transport structure represents, for example, a monomer having three or more radical polymerizable functional groups without a hole transport structure such as triaryl amine, hydrazone, pyrazoline, or carbazole, or an electron transport structure such as condensed polycyclic quinone, diphenoquinone or an electron absorbing aromatic ring having a cyano group or a nitro group.

The radical polymerizable functional group represents any radical polymerizable functional group which has a carbon-carbon double bond.

For example, 1-substituted ethylene functional groups or 1,1-substituted ethylene functional groups is suitably used as the radical polymerizable functional group.

(1) A specific example of 1-substituted ethylene functional group is the functional group represented by the following chemical formula 1.

CH₂═CH—X1 Chemical formula 1

In the chemical formula 1, X1 represents an arylene group such as a substituted or non-substituted phenylene group, and a naphthylene group, a substituted or non-substituted alkenylene group, —CO—, —COO—, —CON(R10) (where R10 represents a hydrogen, an alkyl group such as methyl group and ethyl group, an aralkyl group such as benzyl group, naphthyl methyl group, and phenethyl group, and an aryl group such as phenyl group and naphthyl group), or —S—.

Specific examples of such substitution groups include, but are not limited to, a vinyl group, a styryl group, 2-methyl-1,3-butadienyl group, a vinyl carbonyl group, an acryloyloxy group, an acryloyl amino group, and a vinylthio ether group.

(2) A specific example of 1,1-substituted ethylene functional groups is the functional group represented by the following chemical formula 2.

CH₂═CH(Y)—X2 Chemical formula 2

In the chemical formula 2, Y represents a substituted or non-substituted alkyl group, a substituted or non-substituted aralkyl group, an aryl group such as a substituted or non-substituted phenyl group and naphtylene group, a halogen atom, cyano group, nitro group, an alokoxy group such as methoxy group and ethoxy group, —COOR11 (where R11 represents hydrogen atom, an alkyl group such as a substituted or non-substituted methyl group and ethyl group, an aralkyl group such as a substituted or non-substituted benzyl group, naphthylmethyl group, and phenethyl group, an aryl group such as substituted or non-substituted phenyl group and naphtyl group or —CONR12R13 (where R12 and R13 independently represent hydrogen atoms, alkyl groups such as substituted or non-substituted methyl groups and ethyl groups, aralkyl groups such as substituted or non-substituted benzyl groups, naphthyl methyl groups, and phenethyl groups, or aryl groups such as substituted or non-substituted phenyl groups and naphtyl groups).

X2 represents a single bond, the same substitution group as X1 in the chemical formula 1, or an alkylene group. At least one of Y and X2 is an oxycarbonyl group, a cyano group, an alkenylene group, or an aromatic ring.

Specific examples of these substitution groups include, but are not limited to, an α-acryloyloxy chloride group, a methacryloyloxy group, an α-cyanoethylene group, an α-cyanoacryloyloxy group, an α-cyanophenylene group, and a methacryloyl amino group.

Specific examples of substitution groups further substituted to the substitution groups of X1, X2 and Y include, but are not limited to, a halogen atom, a nitro group, a cyano group, an alkyl group such as a methyl group and an ethyl group, an alkoxy group such as a methoxy group and an ethoxy group, an aryloxy group such as a phenoxy group, an aryl group such as a phenyl group and a naphtyl group, and an aralkyl group such as a benzyl group and a phenetyl group.

Among these radical polymerizable functional groups, an acryloyloxy group and a methacyloyloxy group are particularly suitable. A compound having at least three acryloyloxy groups is obtained by conducting ester reaction or ester conversion reaction using, for example, a compound having at least three hydroxyl groups therein and an acrylic acid (salt), a halide acrylate, and an ester of acrylic acid.

A compound having at least three methacryloyloxy groups is obtained in the same manner. In addition, the radical polymerizable functional groups in a monomer having at least three radical polymerizable functional groups can be the same or different from each other.

The radical polymerizable monomer having at least three functional groups without having a charge transport structure include the following compounds, but are not limited thereto.

Specific examples of the radical polymerizable monomers mentioned above for use in the present invention include, but are not limited to, trimethylol propane triacrylate (TMPTA), trimethylol propane trimethacrylate, HPA modified trimethylol propane triacrylate, EO modified trimethylol propane triacrylate, PO modified trimethylol propane triacrylate, caprolactone modified trimethylol propane triacrylate, HPA modified trimethylol propane triacrylate, pentaerythritol triacrylate, pentaerythritol tetra acrylate (PETTA), glycerol triacrylate, ECH modified glycerol triacrylate, EO modified glycerol triacrylate, PO modified glycerol triacrylate, tris(acryloxyrthyl) isocyanulate, dipenta erythritol hexacrylate (DPHA), caprolactone modified dipenta erythritol hexacrylate, dipenta erythritol hydroxyl dipenta acrylate, alkylized dipenta erythritol tetracrylate, alkylized dipenta erythritol triacrylate, dimethylol propane tetracrylate (DTMPTA), penta erythritol ethoxy tetracrylate, EO modified phosphoric acid triacrylate, and 2,2,5,5-tetrahydroxy methyl cyclopentanone tetracrylate.

These can be used alone or in combination.

In addition, in the radical polymerizable monomer having at least three functional groups without having a charge transport structure for use in the present disclosure, the functional group ratio of the molecular weight to the number of the functional groups is preferably 250 or less to form dense cross-linking bonds in the surface layer.

By this limit, the elastic displacement ratio and the hardness of the surface layer tend to ameliorate and the durability to damage of the surface of a photoreceptor increases.

In addition, the content ratio of the radical polymerizable monomer having three or more functional groups without having a charge transport structure for use in the surface layer is from 20% by weigh to 80% by weight and preferably from 30% by weight to 70% by weight based on the total weight of the surface layer. Substantially, it depends on the ratio of the radical polymerizable monomer having three or more functional groups in the solid portion of the liquid application.

When the monomer content ratio is too small, the density of three-dimensional cross-linking bonding in the surface layer tends to be small. Therefore, drastic improvement of the durability to damage thereof is not expected in comparison with a case in which a typical thermal plastic binder resin is used.

When the monomer content ratio is too large, the content of the charge transport compound decreases, which may cause degradation of the electric characteristics, in particular the residual voltage rise and the degradation of the sensitivity.

Desired electrostatic characteristics and abrasion resistance vary depending on the process used. Therefore, it is difficult to jump to any conclusion but considering the balance of both properties, the range of from 30% by weight to 70% by weight is most preferred.

The radical polymerizable compound having a functional group with a charge transport structure for use in the present disclosure includes, for example, compounds having a radical polymerizable functional group and a hole transport structure such as triaryl amine, hydrazone, pyrazoline, or carbazole or an electron transport structure such as a condensed polycyclic quinone, diphenoquinone, and an electron absorbing aromatic ring having a cyano group or a nitro group.

The radical polymerizable monomers mentioned above can be suitably used as the radical polymerizable functional groups. Among these, acryloyloxy group and methcryloyloxy group are particularly suitable. In addition, triaryl amine structure is preferable as the charge transport structure. Furthermore, when the compound represented by the following Chemical structure 1 or 2 is used, the electric characteristics such as sensitivity and residual voltage are preferably sustained.

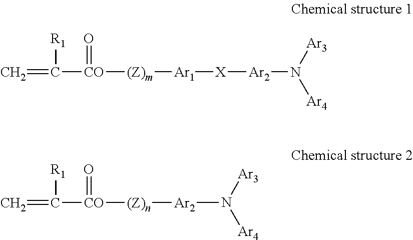

In the Chemical structures 1 and 2, R₁ represents a hydrogen atom, a halogen atom, a substituted or non-substituted alkyl group, a substituted or non-substituted aralky group, a substituted or non-substituted aryl group, a cyano group, a nitro group, an alkoxy group, —COOR7, wherein R7 represents a hydrogen atom, a substituted or non-substituted alkyl group, a substituted or non-substituted aralkyl group or a substituted or non-substituted aryl group, a halogenated carbonyl group or CONR8R9, wherein R8 and R9 independently represent hydrogen atoms, halogen atoms, substituted or non-substituted alkyl groups, substituted or non-substituted aralkyl groups, or substituted or non-substituted aryl groups, and Ar₁ and Ar₂ independently represent substituted or non-substituted arylene groups. Ar₃ and Ar₄ independently represent a substituted or non-substituted aryl group.

X represents a single bond, a substituted or non-substituted alkylene group, a substituted or non-substituted cycloalkylene group, a substituted or non-substituted alkylene ether group, an oxygen atom, a sulfur atom, or a vinylene group. Z represents a substituted or non-substituted alkylene group, a substituted or non-substituted alkylene ether group, or an alkyleneoxy carbonyl group. m and n represent an integer of from 0 to 3.

Specific examples of the Chemical structures 1 and 2 include, but are not limited to, the following.

In the Chemical structures 1 and 2, as the substitution groups of R₁, specific examples of the alkyl groups of R1 include, but are not limited to, methyl group, ethyl group, propyl group, and butyl group. Specific examples of the aryl groups of R₁ include, but are not limited to, phenyl group and naphtyl group. Specific examples of the aralkyl groups of R₁ include, but are not limited to, benzyl group, phenthyl group, naphtyl methyl group. The alkoxy group of R₁ include, but are not limited to, methoxy group, ethoxy group and propoxy group.

These can be substituted by a halogen atom, nitro group, a cyano group, an alkyl group such as a methyl group and an ethyl group, an alkoxy group such as a methoxy group and an ethoxy group, an aryloxy group such as a phenoxy group, an aryl group such as a phenyl group and a naphtyl group and an aralkyl group such as a benzyl group and a phenthyl group.

Among these substitution groups for R₁, a hydrogen atom and a methyl group are particularly preferable.

Ar₃ and Ar₄ represent substituted or non-substituted aryl groups. Specific examples thereof include, but are not limited to, condensed polycyclic hydrocarbon groups, non-condensed ring hydrocarbon groups and heterocyclic groups.

Specific examples of the condensed polycyclic hydrocarbon groups include, but are not limited to, a group in which the number of carbons forming a ring is not greater than 18 such as a pentanyl group, an indenyl group, a naphtyl group, an azulenyl group, a heptalenyl group, a biphenylenyl group, an as-indacenyl group, an s-indacenyl group, a fluorenyl group, an acenaphtylenyl group, a pleiadenyl group, an acenaphtenyl group, a phenalenyl group, a phenanthryl group, an anthryl group, a fluorantenyl group, an acephenantrirenyl group, an aceantrirenyl group, a triphenylene group, a pyrenyl group, a chrysenyl group, and a naphthacenyl group.

Specific examples of the non-condensed ring hydrocarbon groups include, but are not limited to, a single-valent group of monocyclic hydrocarbon compounds such as benzene, diphenyl ether, polyethylene diphenyl ether, diphenylthio ether and phenylsulfon, a single-valent group of non-condensed polycyclic hydrocarbon compounds such as biphenyl, polyphenyl, diphenyl alkane, diphenyl alkene, diphenyl alkyne, triphenyl methane, distyryl benzene, 1,1-diphenyl cycloalkane, polyphenyl alkane and polyphenyl alkene or a single-valent group of ring aggregated hydrocarbon compounds such as 9,9-diphenyl fluorene.

Specific examples of the heterocyclic groups include, but are not limited to, a single-valent group such as carbazol, dibenzofuran, dibenzothiophene, oxadiazole, and thiadiazole.

The aryl groups represented by Ar₃ and Ar₄ can have a substitution group. Specific examples thereof are as follows:

(1) Halogen atom, cyano group, and nitro group;
(2) Alkyl group, preferably a straight chained or side chained alkyl group having 1 to 12, more preferably 1 to 8 and furthermore preferably from 1 to 4 carbon atoms. These alkyl groups can have a fluorine atom, a hydroxyl group, cyano group, an alkoxy group having 1 to 4 carbon atoms, a phenyl group or a phenyl group substituted by a halogen atom, an alkyl group having 1 to 4 carbon atoms or an alkoxy group having 1 to 4 carbon atoms. Specific examples thereof include, but are not limited to, a methyl group, an ethyl group, an n-butyl group, an I-propyl group, a t-butyl group, an s-butyl group, an n-propyl group, a trifluoromethyl group, a 2-hydroxy ethyl group, a 2-ethoxyethyl group, a 2-cyanoethyl group, a 2-methoxyethyl group, a benzyl group, a 4-chlorobenzyl group, a 4-methyl benzyl group, and a 4-phenyl benzyl group;
(3) Alkoxy group (—OR2), and R2 represents the alkyl group defined in (2).

Specific examples thereof include, but are not limited to, a methoxy group, an ethoxy group, an n-propoxy group, an i-propoxy group, a t-butoxy group, an n-butoxy group, an s-butoxy group, an i-butoxy group, a 2-hydroxy ethoxy group, a benzyl oxy group, and a trifluoromethoxy group;

(4) Aryloxy group, and specific examples of the aryl group of the aryloxy group include, but are not limited to, a phenyl group and a naphtyl group.

These can contain an alkoxy group having 1 to 4 carbon atoms, an alkyl group having 1 to 4 carbon atoms, or a halogen atom as a substitution group. Specific examples thereof include, but are not limited to, a phenoxy group, a 1-naphtyloxy group, a 2-naphtyloxy group, a 4-methoxyphenoxy group, and a 4-methylphenoxy group;

(5) An alkyl mercapto group or an aryl mercapto group;

Specific examples thereof include, but are not limited to, a methylthio group, an ethylthio group, a phenylthio group, and a p-methylphenylthio group;

(6)

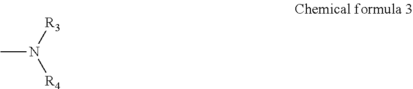

In Chemical formula 3, R₃ and R₄ independently represent hydrogen atoms, the alkyl groups defined in (2), or aryl groups. Specific examples of the aryl group include, but are not limited to, a phenyl group, a biphenyl group, or a naphtyl group.

These can contain an alkoxy group having 1 to 4 carbon atoms, an alkyl group having 1 to 4 carbon atoms, or a halogen atom as a substitution group. R3 and R4 can share a linkage to form a ring.

Specific examples thereof include, but are not limited to, an amino group, a diethyl amino group, an N-methyl-N-phenyl amino group, an N,N-diphenyl amino group, an N,N-di(tolyl) amino group, a dibenzyl amino group, a piperidino group, a morpholino group, and a pyrrolidino group;

(7) An alkylene dioxy group or an alkylene dithio group such as a methylene dioxy group and a methylene dithio group; and
(8) A substituted or non-substituted styryl group, a substituted or non-substituted β-phenyl styryl group, a diphenyl aminophenyl group, a ditolyl aminophenyl group, etc.

The arylene groups represented by Ar₁ and Ar₂ specified above are divalent groups derived from the aryl group represented by Ar₃ and Ar₄ mentioned above.

X represents a single bond, a substituted or non-substituted alkylene group, a substituted or non-substituted cycloalkylene group, a substituted or non-substituted alkylene ether group, an oxygen atom, a sulfur atom, or a vinylene group.

A straight chained or side chained alkyl group having 1 to 12, more preferably 1 to 8, and furthermore preferably from 1 to 4 carbon atoms is preferably specified. These alkyl groups can have a fluorine atom, a hydroxyl group, an alkoxy group having 1 to 4 carbon atoms, a phenyl group or a phenyl group substituted by a halogen atom, an alkyl group having 1 to 4 carbon atoms or an alkoxy group having 1 to 4 carbon atoms. Specific examples thereof include, but are note limited to, a methylene group, an ethylene group, an n-butylene group, an i-propylene group, a t-butylene group, an s-butylene group, an n-propylene group, a trifluoromethylene group, a 2-hydroxy ethylene group, a 2-ethoxyethylene group, a 2-cyanoethylene group, a 2-methoxyethylene group, a benzylidene group, a phenyl ethylene group, a 4-chlorophenyl ethylene group, a 4-methylpheny ethylene group, and a 4-biphenyl ethylene group.

A specific example of the substituted or non-substituted cycloalkylene group is a cyclic alkylene group having 5 to 7 carbon atoms. These cyclic alkylene groups can have a fluorine atom, a hydroxyl group, an alkyl group having 1 to 4 carbon atoms, and an alkoxy group having 1 to 4 carbon atoms.

Specific examples thereof include, but are not limited to, a cyclohexylidene group, a cyclohexylene group, and a 3,3-dimethyl cyclohexylidene group.

Specific examples of the substituted or non-substituted alkylene ether group include, but are not limited to, an ethyleneoxy group, a propyleneoxy group, an ethylene glycol group, a propylene glycol group, a diethylene glycol group, a tetraethylene glycol group, and a tripropylene glycol group.

The alkylene group of the alkylene ethere group may have a substitution group such as a hydroxyl group, a methyl group, or an ethyl group.

The vinylene group is represented by the following Chemical formula 4 or 5.

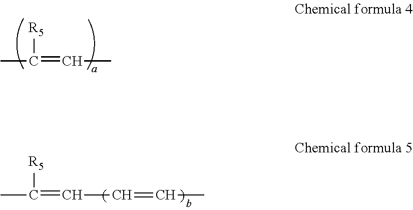

In the chemical formula 4 or 5, R₅ represents hydrogen or an alkyl group (the same as the alkyl groups defined in (2), an aryl group (the same as the aryl groups defined for Ar₃ and Ar₄), “a” represents 1 or 2, and “b” is an integer of from 1 to 3.

Z represents a substituted or non-substituted alkylene group, a substituted or non-substituted alkylene ether group. or an alkyleneoxy carbonyl group.

Specific examples of the substituted or non-substituted alkylene group are the same as the alkylene group specified for X.

Specific examples of the substituted or non-substituted alkylene ether group are the same as the alkylene ether group specified for X.

A specific example of the alkyleneoxy carbonyl group is a caprolactone modified group.

The compound represented by the following Chemical structure 3 is a furthermore preferable radical polymerizable compound having one functional group with a charge transport structure.

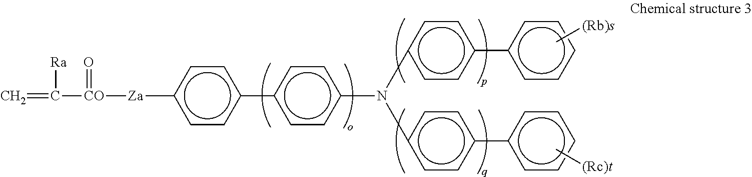

In Chemical structure 3, “o”, “p”, “q” represent 0 or 1, Ra represents a hydrogen atom or methyl group, Rb and Rc are not hydrogen atom but independently represent alkyl groups having 1 to 6 carbon atoms. “s” and “t” represent integers of from 0 to 3. Za represents a single bond, a methylene group, an ethylene group, —CH₂CH₂O—, CH₃CHCH₂O—, or C₆H₅CH₂CH₂—.

Among the compounds represented by the Chemical structure 4 illustrated above, the compounds having a methyl group or an ethyl group as the substitution group of Rb and Rc are particularly preferable.

The radical polymerizable compound having a functional group with a charge transport structure for use in the present disclosure represented by the Chemical structures 1, 2, or 3 in particular is polymerized in a manner that both sides of the carbon-carbon double bonding are open.

Therefore, the radical polymerizable compound does not constitute an end of the structure and is set in a chained polymer. The radical polymerizable compound having a functional group is present in the main chain of a polymer in which cross-linking is formed by polymerization with a radical polymerizable monomer having three functional groups or a cross-linking chain between the main chains.

There are two kinds of the cross-linking chains. One is the cross-linking chain between a polymer and another polymer and the other is the cross-linking chain formed by cross-linking a portion in the main chain present in a folded state in a polymer and a moiety derived from a monomer polymerized away from the portion.

Whether a radical polymerizable compound having a functional group with a charge transport structure is present in the main chain or in a cross-linking chain, the triaryl amine structure suspends from the chain portion. The triaryl amine structure has at least three aryl groups disposed in the radial directions from the nitrogen atom therein. Although such a triaryl amine structure is bulky, it does not directly bind with the chain portion but suspends from the chain portion via a carbonyl group, etc. That is, the triaryl amine structure is stereoscopically fixed in a flexible state.

Therefore, these triaryl amine structures can be adjacent to each other with a moderate space. Therefore, the structural distortion is slight in a molecule. In addition, when the structure is used in the surface layer of an image bearing member (photoreceptor), it can be deduced that the internal molecular structure can have a structure in which there are relatively few disconnections in the charge transport route.

Specific examples of the radical polymerizable compound having one functional group with a charge transport structure include, but are not limited to, the following compounds, but are not limited thereto.

TABLE 1-1

| | |
|---|---|
| 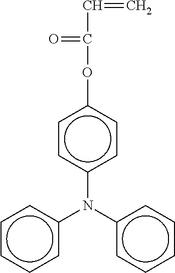 | No. 1 |
| 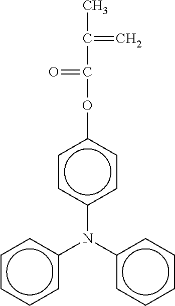 | No. 2 |
| 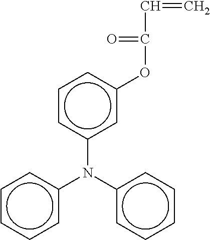 | No. 3 |
| 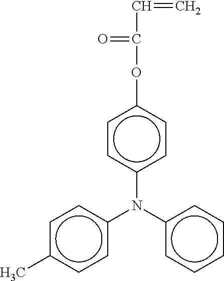 | No. 4 |
| 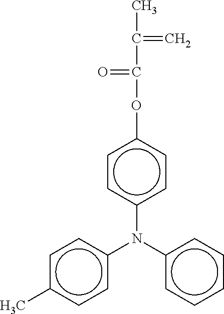 | No. 5 |
| 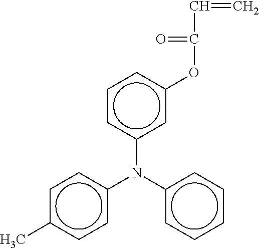 | No. 6 |
| 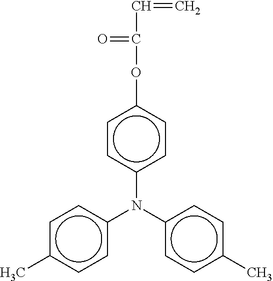 | No. 7 |
| 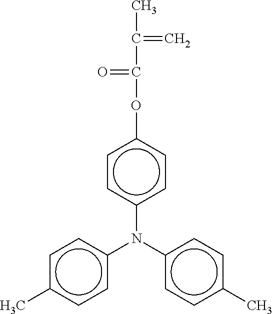 | No. 8 |
| 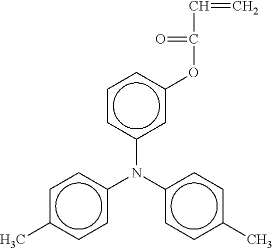 | No. 9 |
| 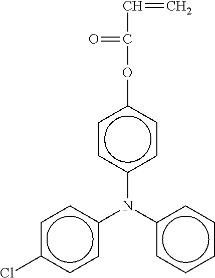 | No. 10 |
| 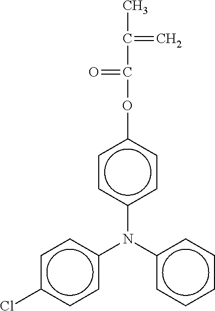 | No. 11 |
| 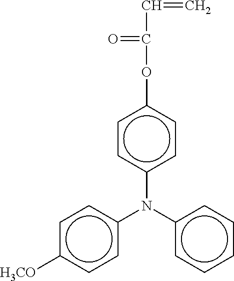 | No. 12 |
| 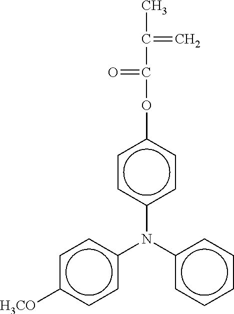 | No. 13 |
| 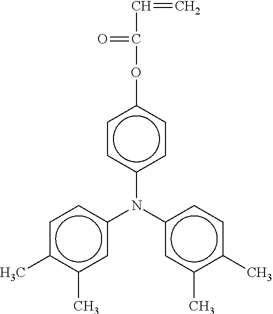 | No. 14 |
| 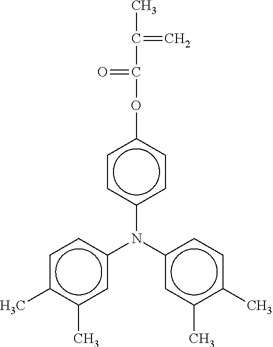 | No. 15 |
| 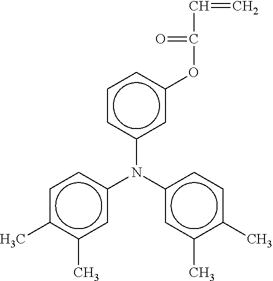 | No. 16 |

TABLE 1-2

| | |
|---|---|
| 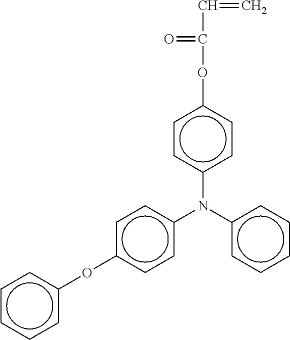 | No. 17 |
| 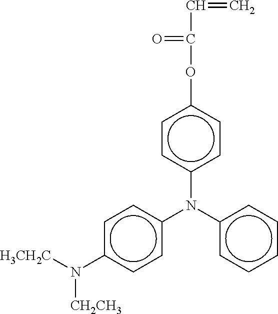 | No. 18 |
| 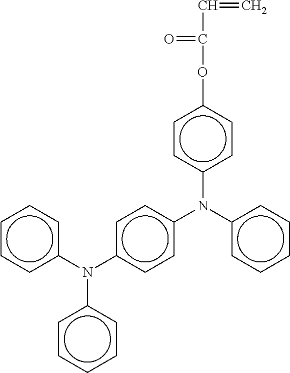 | No. 19 |
| 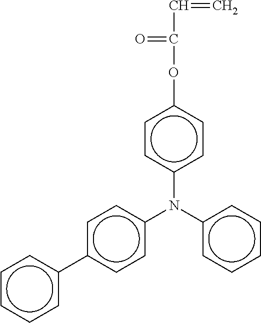 | No. 20 |
| 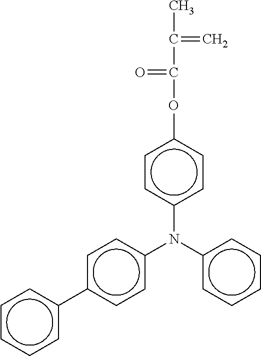 | No. 21 |
| 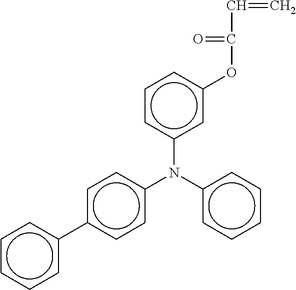 | No. 22 |
| 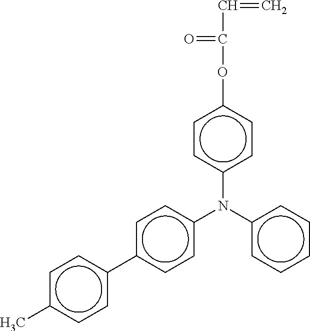 | No. 23 |
| 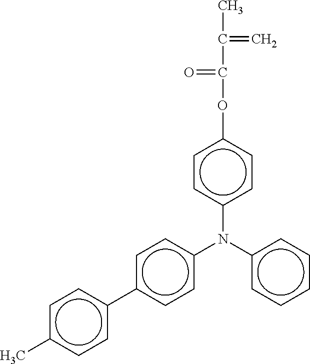 | No. 24 |
| 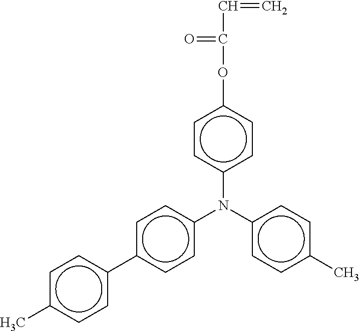 | No. 25 |
| 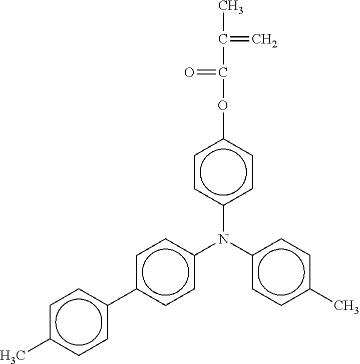 | No. 26 |
| 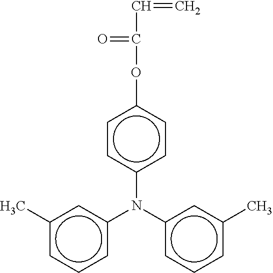 | No. 27 |
| 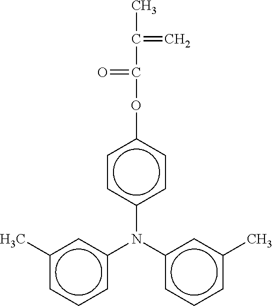 | No. 28 |
| 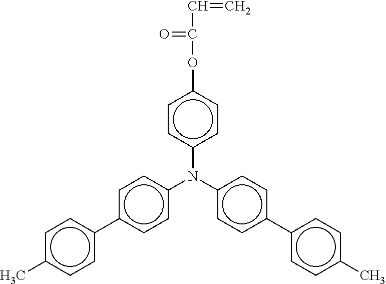 | No. 29 |
| 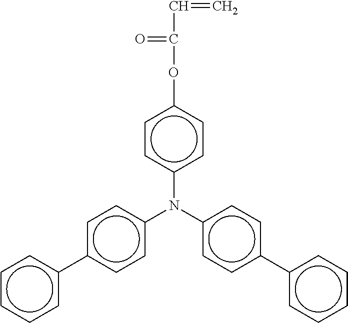 | No. 30 |
| 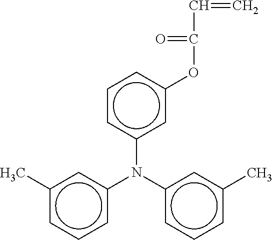 | No. 31 |
| 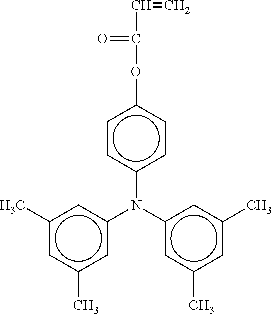 | No. 32 |

TABLE 1-3

| | |
|---|---|
| 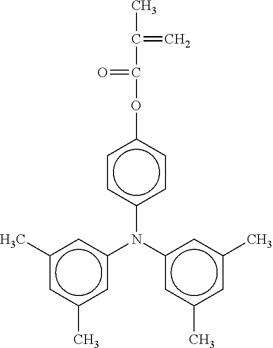 | No. 33 |
| 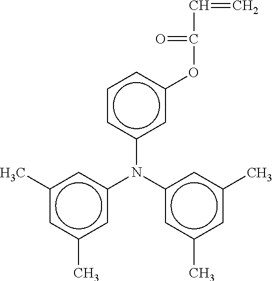 | No. 34 |
| 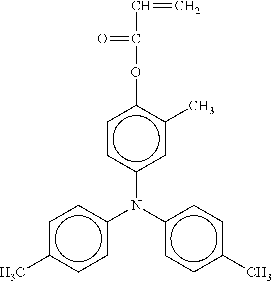 | No. 35 |
| 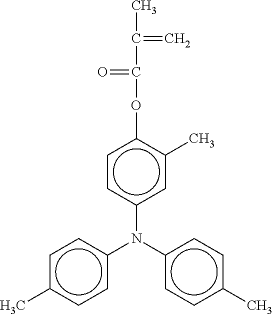 | No. 36 |
| 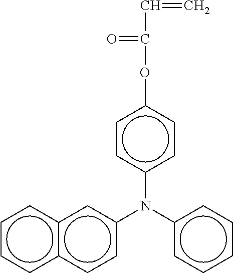 | No. 37 |
| 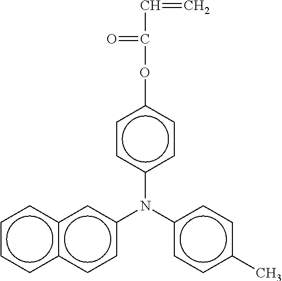 | No. 38 |
| 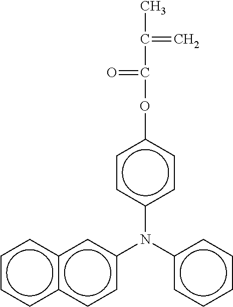 | No. 39 |
| 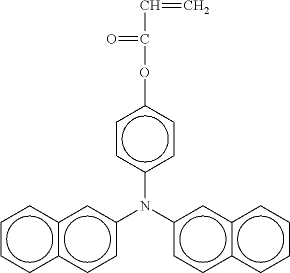 | No. 40 |
| 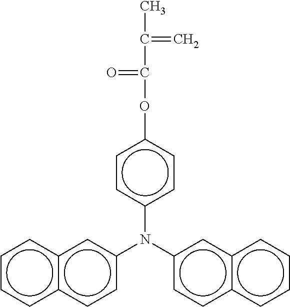 | No. 41 |
| 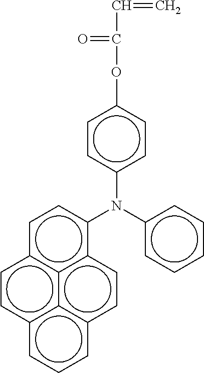 | No. 42 |
| 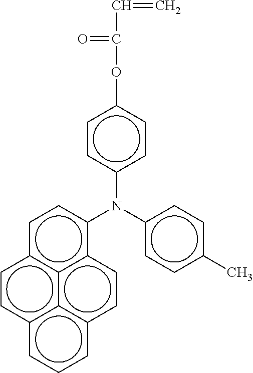 | No. 43 |
| 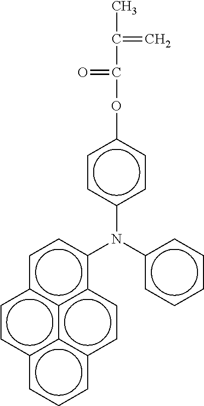 | No. 44 |
| 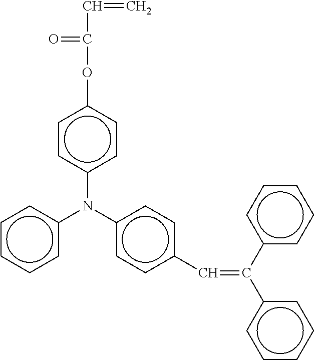 | No. 45 |
| 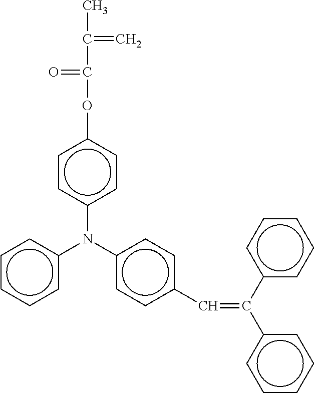 | No. 46 |
| 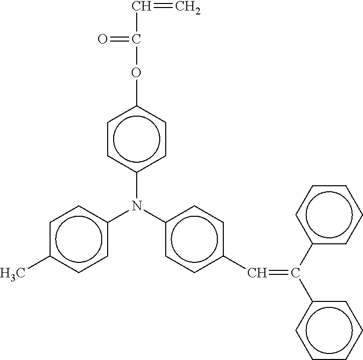 | No. 47 |
| 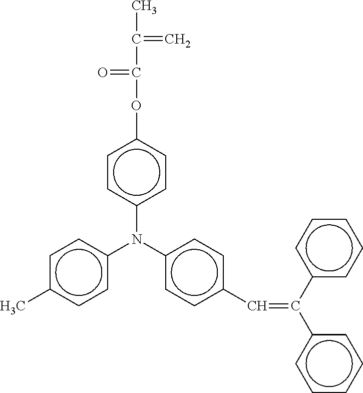 | No. 48 |

TABLE 1-4

| | |
|---|---|
| 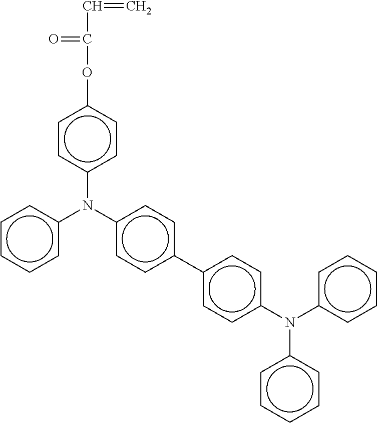 | No. 49 |
| 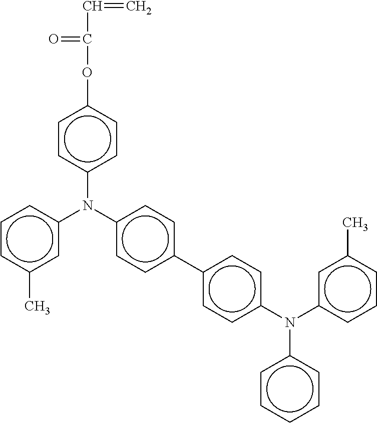 | No. 50 |
| 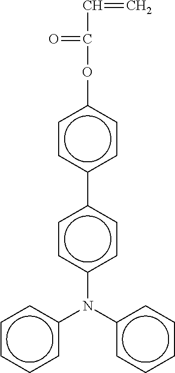 | No. 51 |
| 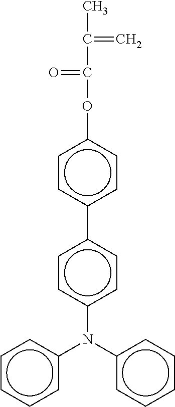 | No. 52 |
| 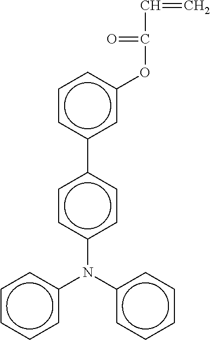 | No. 53 |
| 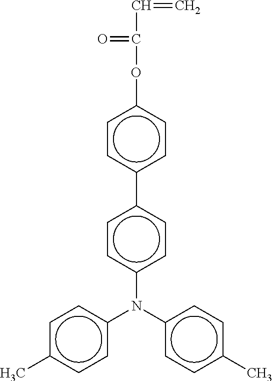 | No. 54 |
| 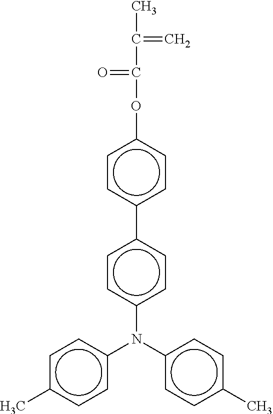 | No. 55 |
| 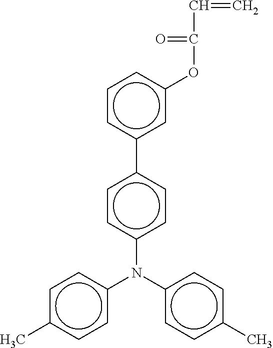 | No. 56 |
| 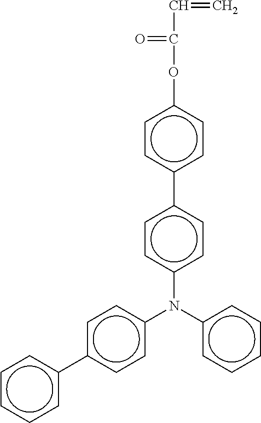 | No. 57 |
| 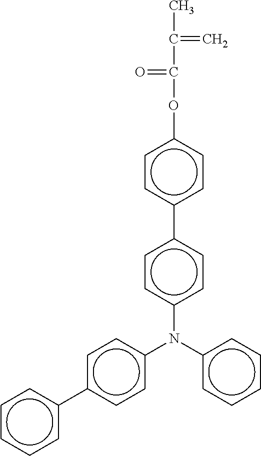 | No. 58 |
| 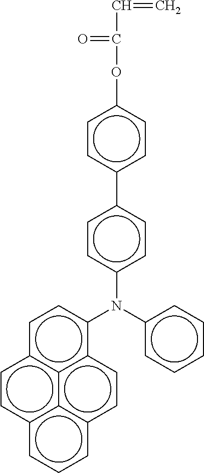 | No. 59 |
| 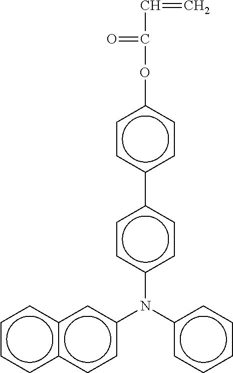 | No. 60 |

TABLE 1-5

| | |
|---|---|
| 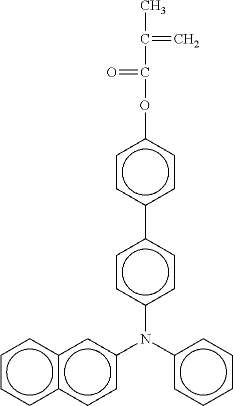 | No. 61 |
| 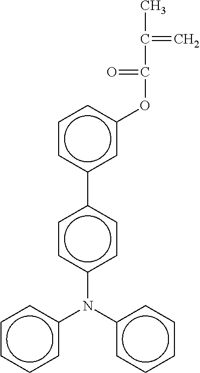 | No. 62 |
| 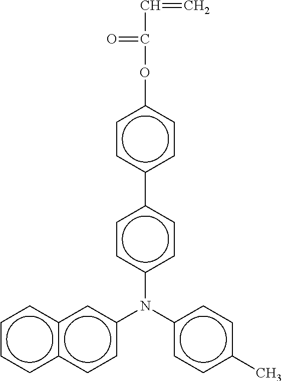 | No. 63 |
| 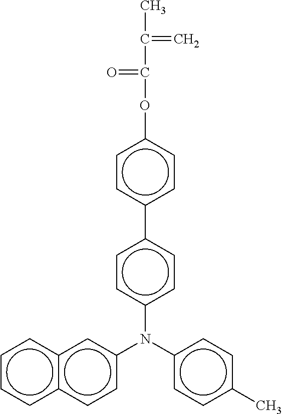 | No. 64 |
| 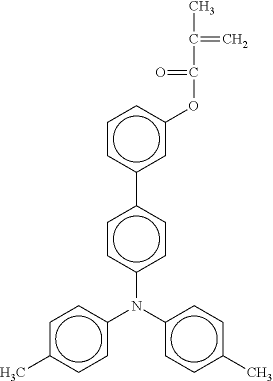 | No. 65 |
| 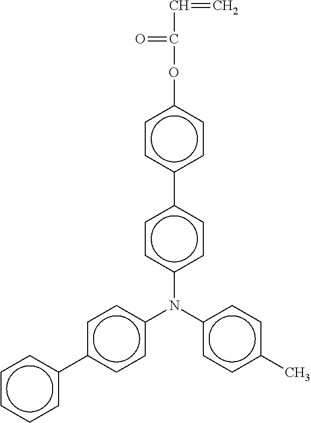 | No. 66 |
| 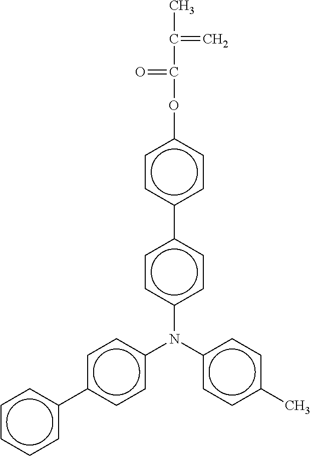 | No. 67 |
| 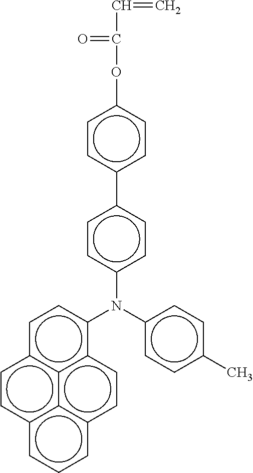 | No. 68 |
| 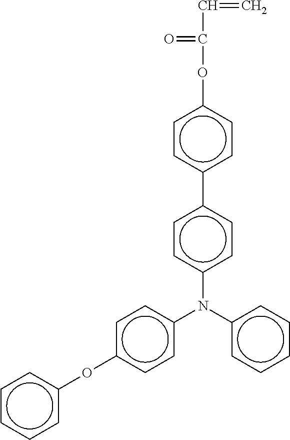 | No. 69 |
| 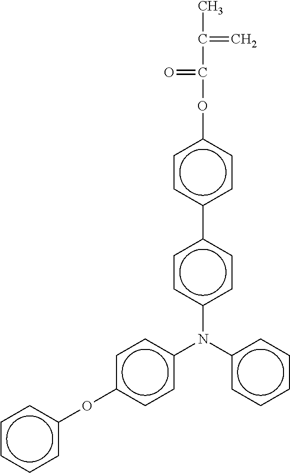 | No. 70 |
| 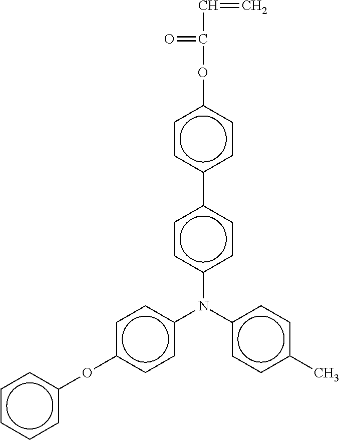 | No. 71 |
| 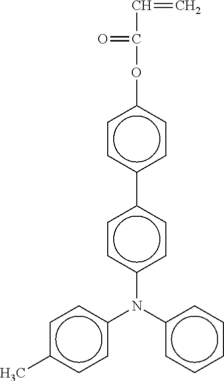 | No. 72 |

TABLE 1-6

| | |
|---|---|
| 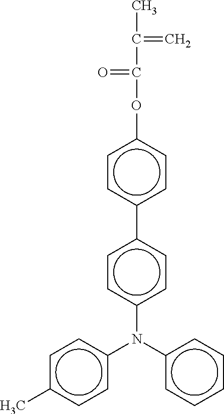 | No. 73 |
| 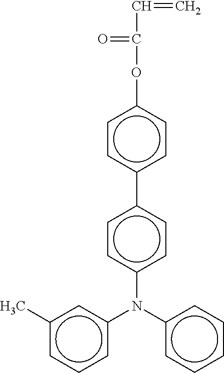 | No. 74 |
| 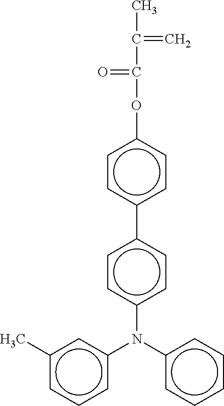 | No. 75 |
| 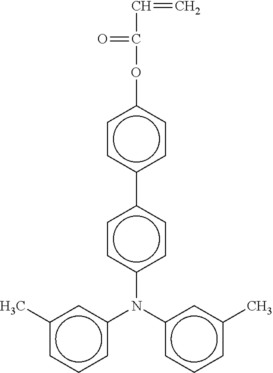 | No. 76 |
| 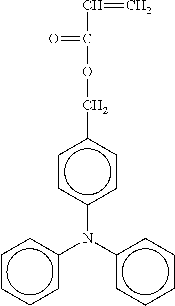 | No. 77 |
| 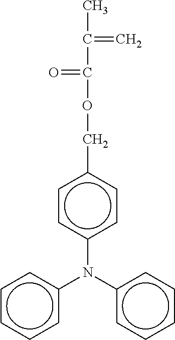 | No. 78 |
| 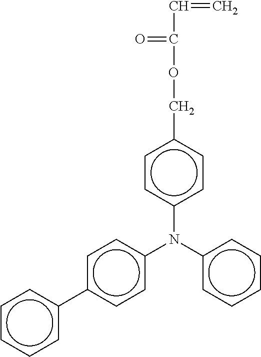 | No. 79 |
| 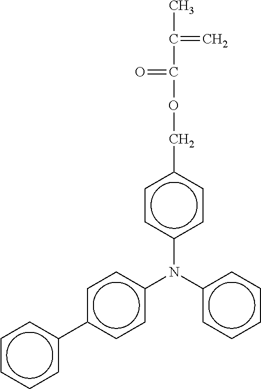 | No. 80 |
| 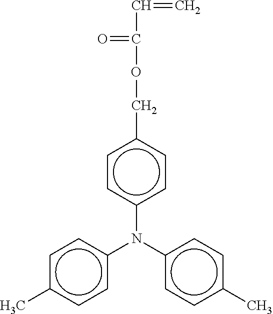 | No. 81 |
| 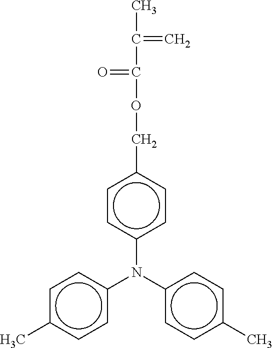 | No. 82 |
| 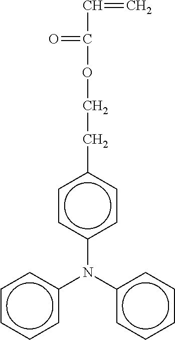 | No. 83 |
| 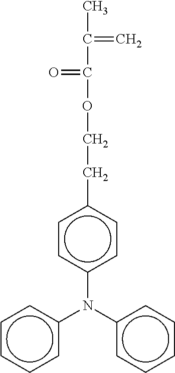 | No. 84 |
| 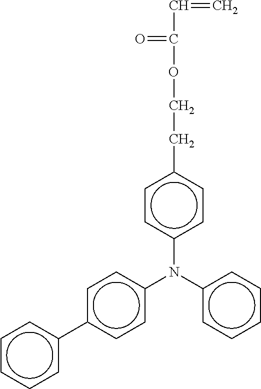 | No. 85 |
| 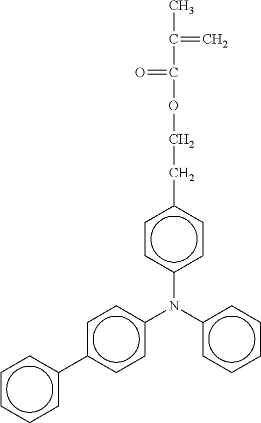 | No. 86 |
| 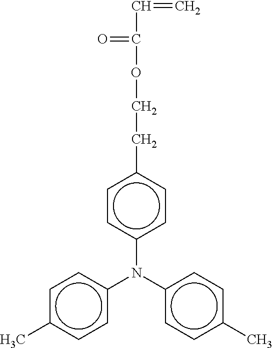 | No. 87 |
| 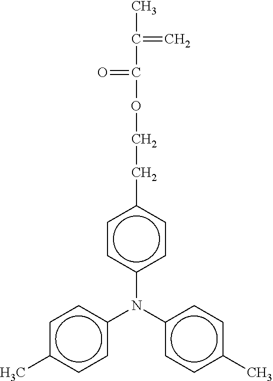 | No. 88 |

TABLE 1-7

| | |
|---|---|
| 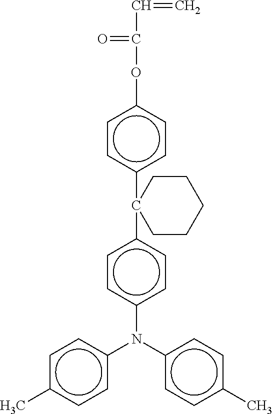 | No. 89 |
| 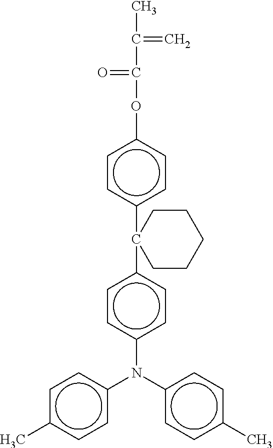 | No. 90 |
| 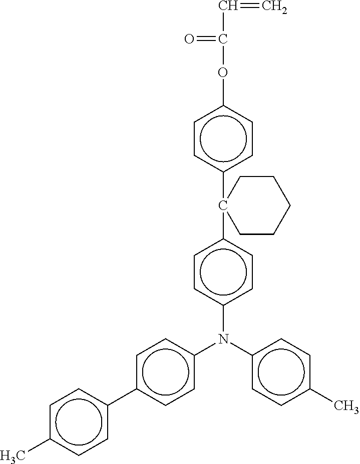 | No. 91 |
| 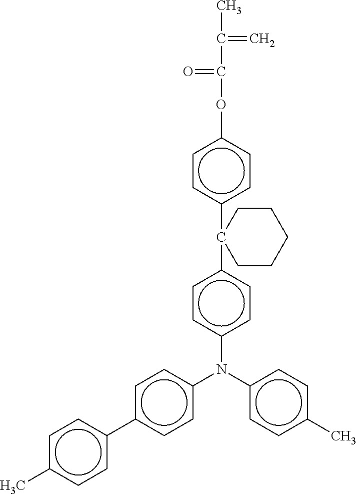 | No. 92 |
| 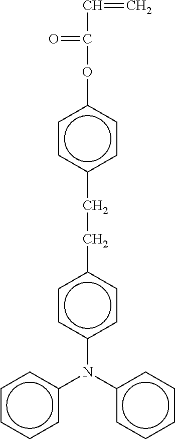 | No. 93 |
| 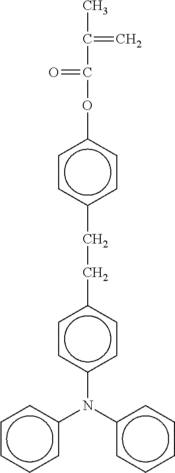 | No. 94 |
| 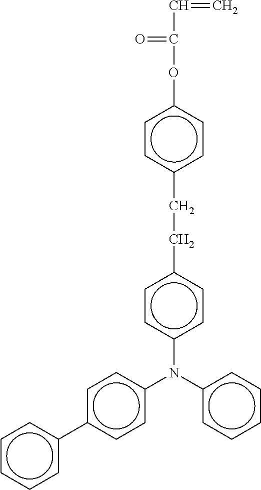 | No. 95 |
| 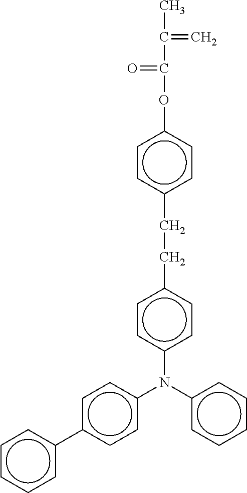 | No. 96 |
| 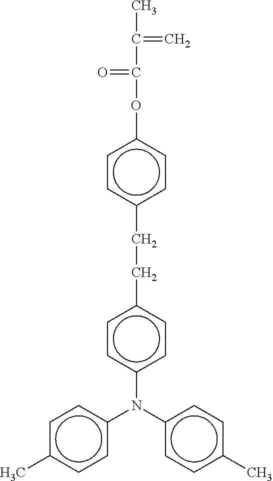 | No. 97 |
| 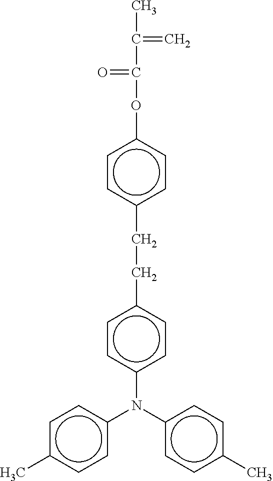 | No. 98 |
| 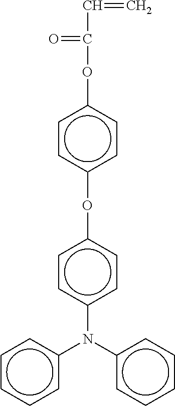 | No. 99 |
| 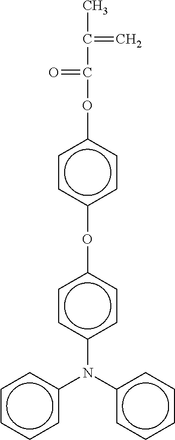 | No. 100 |

TABLE 1-8

| | |
|---|---|
| 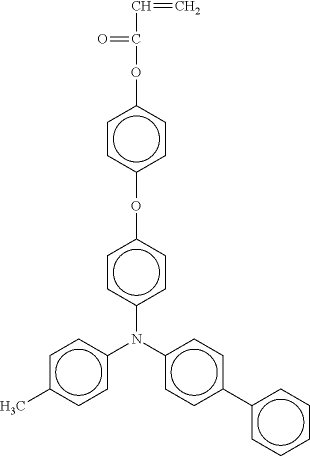 | No. 101 |
| 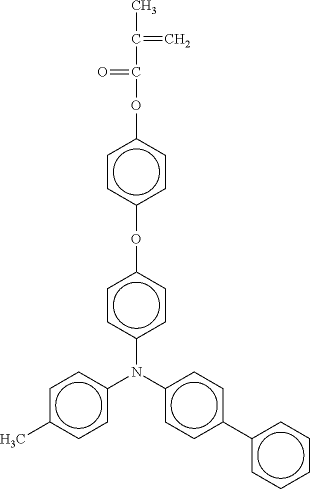 | No. 102 |
| 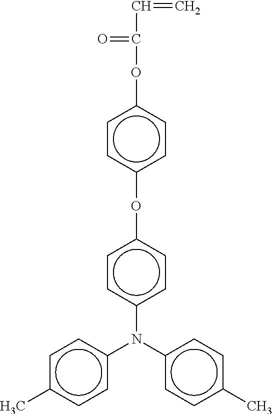 | No. 103 |
| 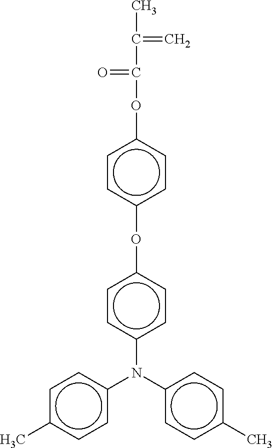 | No. 104 |
| 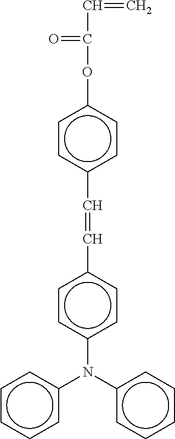 | No. 105 |
| 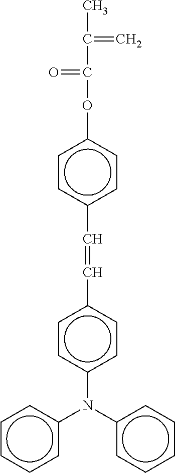 | No. 106 |
| 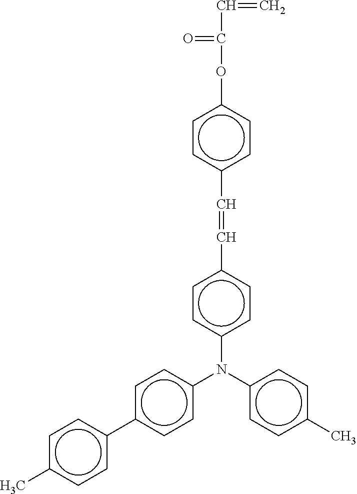 | No. 107 |
| 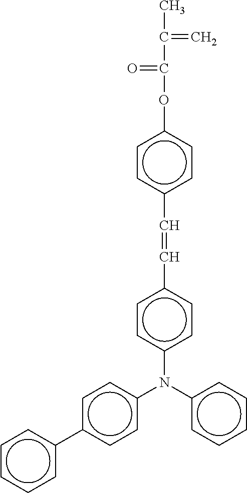 | No. 108 |
| 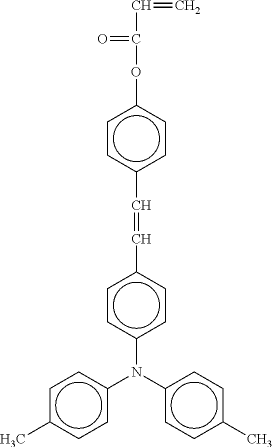 | No. 109 |
| 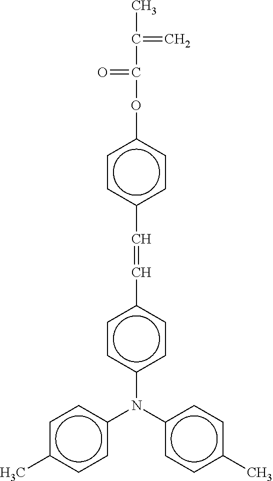 | No. 110 |
| 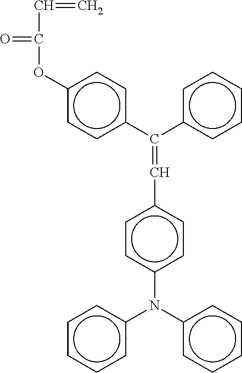 | No. 111 |
| 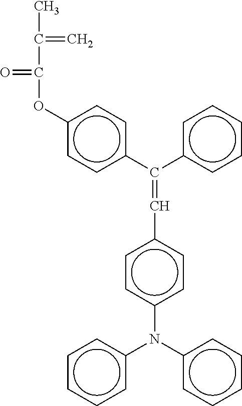 | No. 112 |

TABLE 1-9

| | |
|---|---|
| 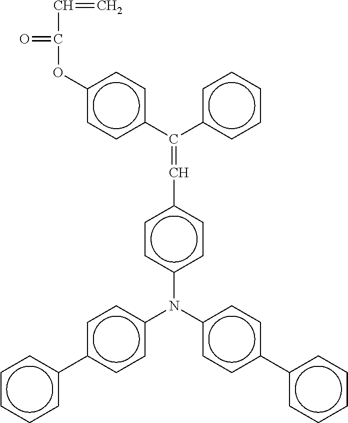 | No. 113 |
| \ 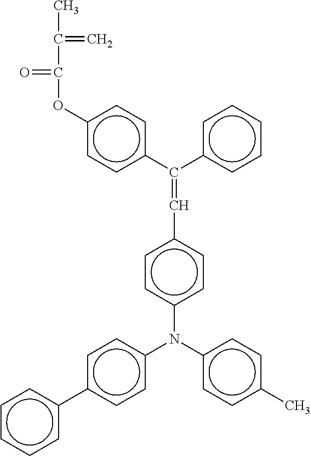 | No. 114 |
| 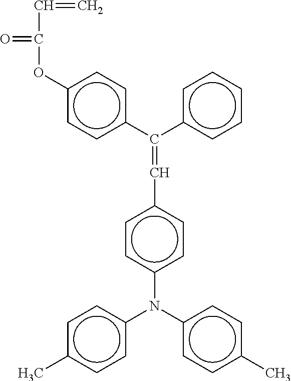 | No. 115 |
| 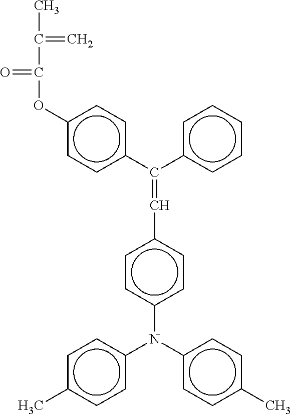 | No. 116 |
| 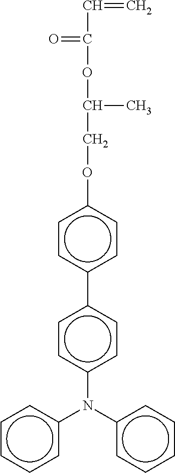 | No. 117 |
| 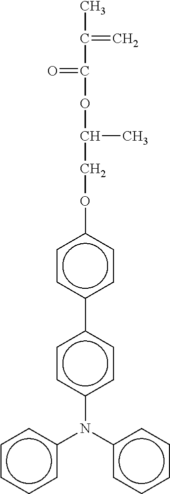 | No. 118 |
| 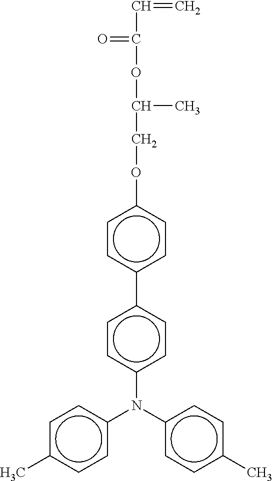 | No. 119 |
| 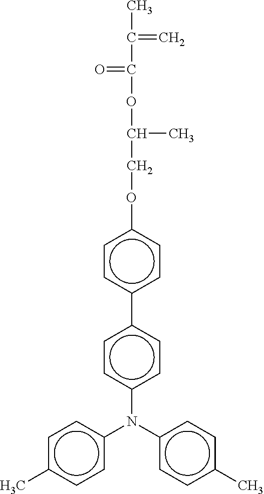 | No. 120 |
| 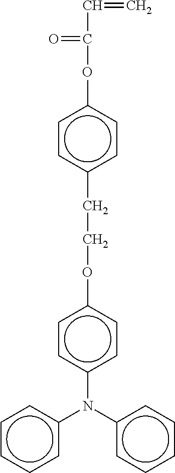 | No. 121 |
| 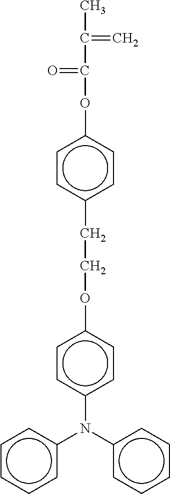 | No. 122 |
| 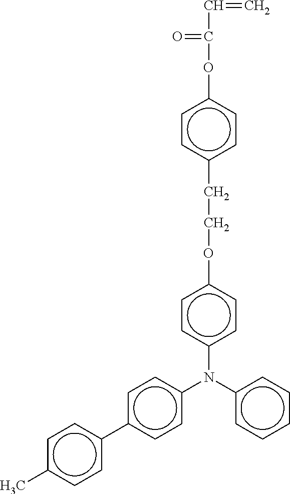 | No. 123 |
| 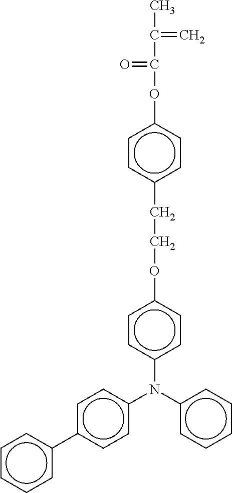 | No. 124 |

TABLE 1-10

| | |
|---|---|
| 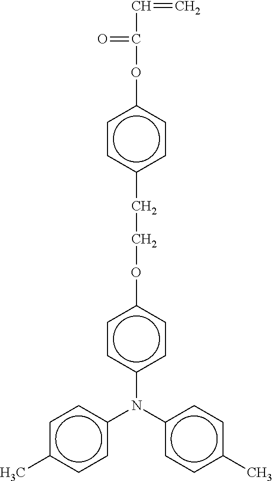 | No. 125 |
| 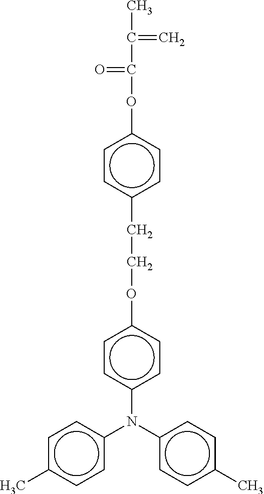 | No. 126 |
| 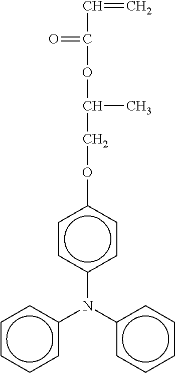 | No. 127 |
| 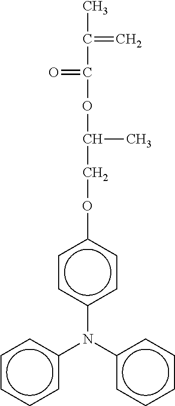 | No. 128 |
| 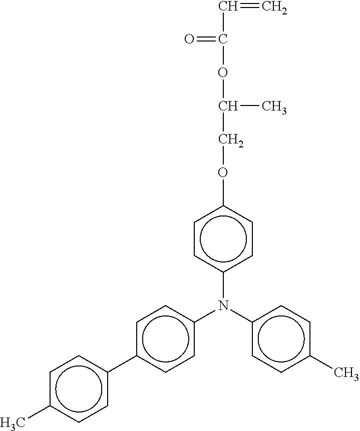 | No. 129 |
| 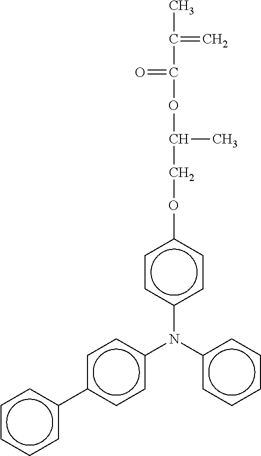 | No. 130 |
| 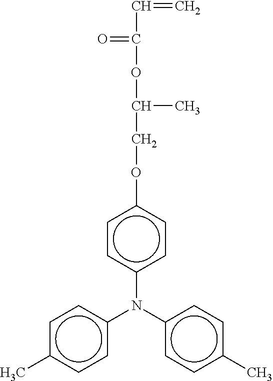 | No. 131 |
| 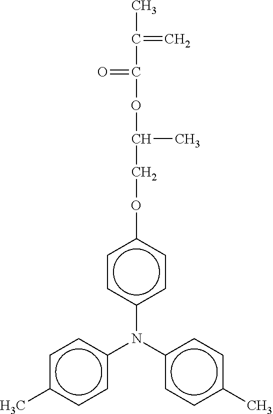 | No. 132 |
| 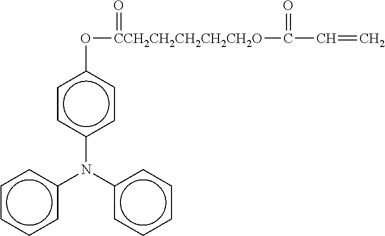 | No. 133 |
| 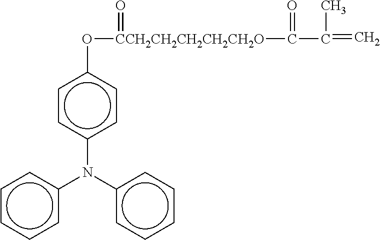 | No. 134 |
| 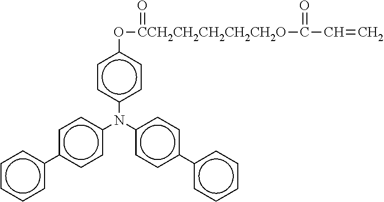 | No. 135 |
| 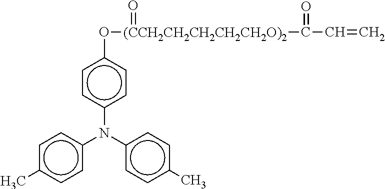 | No. 136 |

TABLE 1-11

| | |
|---|---|
| 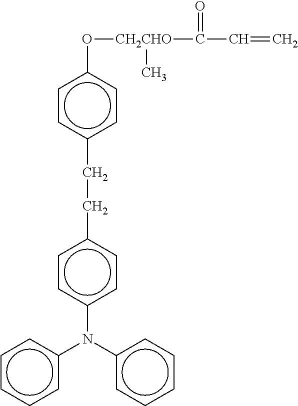 | No. 137 |
| 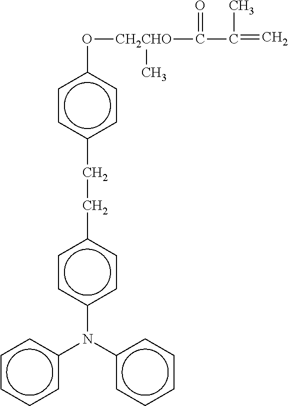 | No. 138 |
| 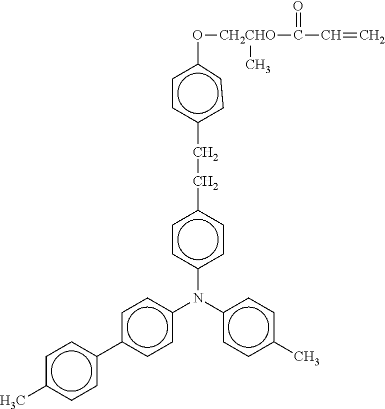 | No. 139 |
| 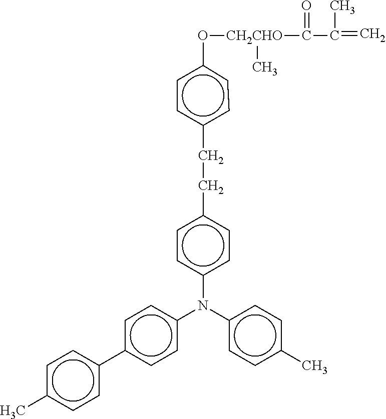 | No. 140 |
| 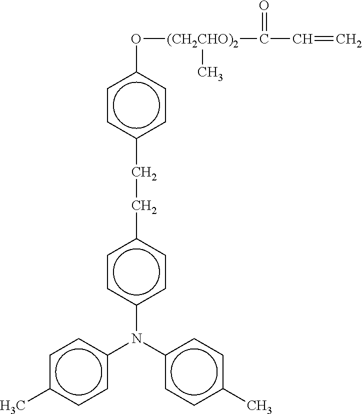 | No. 141 |
| 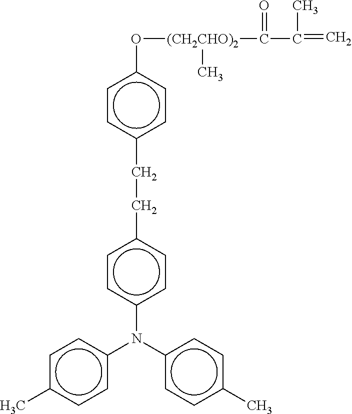 | No. 142 |
| 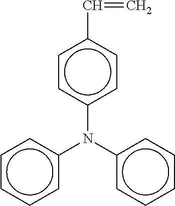 | No. 143 |
| 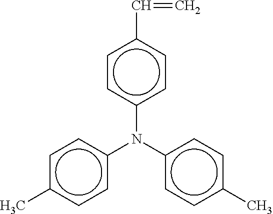 | No. 144 |
| 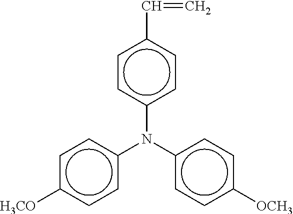 | No. 145 |
| 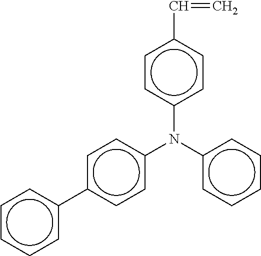 | No. 146 |
| 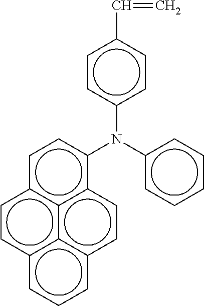 | No. 147 |
| 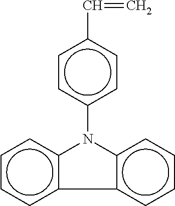 | No. 148 |
| 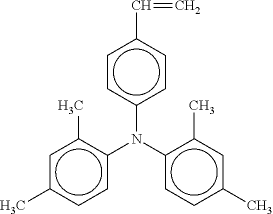 | No. 149 |

TABLE 1-12

| | |
|---|---|
| 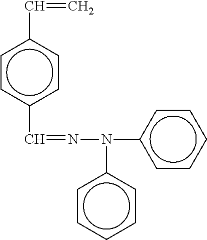 | No. 150 |
| 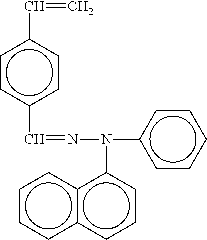 | No. 151 |
| 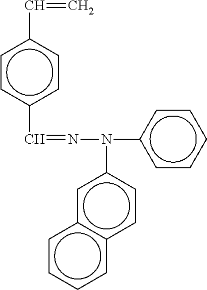 | No. 152 |
| 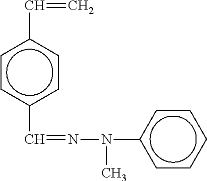 | No. 153 |
| 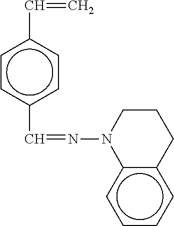 | No. 154 |
| 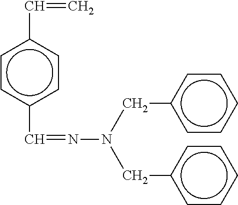 | No. 155 |
| 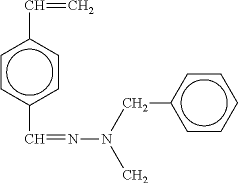 | No. 156 |
| 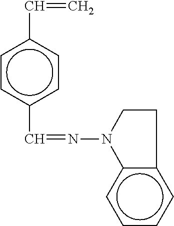 | No. 157 |
| 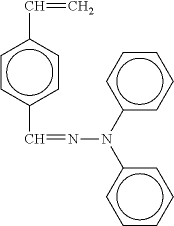 | No. 158 |
| 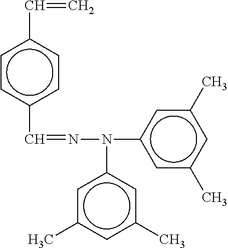 | No. 159 |
| 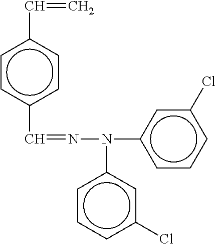 | No. 160 |

In addition, the radical polymerizable compound having one functional group with a charge transport structure for use in the present disclosure imparts a charge transport power to the surface layer and the content ratio of the radical polymerizable compound is from 20% by weight to 80% by weight and preferably from 30% by weight to 70% by weight based on the total weight of the surface layer.

When the content of this component is excessively small, the charge transport power of the surface layer tends not to be sustained, which leads to deterioration of electric characteristics such as sensitivity and a rise of residual voltage over repetitive use.

A content of the radical polymerizable monomer having a charge transport structure that is excessively large tends to invite reduction of the content of a monomer having three functional groups without a charge transport structure. This easily leads to a decrease of the cross-linking density, which prevents demonstration of a high abrasion resistance.

Desired electric characteristics and abrasion resistance vary depending on the process used. Therefore, it is difficult to jump to any conclusion but taking into account the balance of both characteristics, the range of from 30% by weight to 70% by weight is most preferable.

Therefore, in the present disclosure, a surface layer formed by curing a radical polymerizable monomer having three or more functional groups with no charge transport structure and a radical polymerizable compound having a functional group with a charge transport structure is preferable but it is possible to use a radical polymerizable monomer or oligomer having one or two functional groups, a functional monomer, or a combination thereof.

Any known radical polymerizable monomers and oligomers can be used.

Specific examples of such radical monomers having one functional group include, but are not limited to, 2-ethyl hexyl acrylate, 2-hydroxy ethyl acrylate, 2-hydroxy propyl acrylate, tetrahydroflu frylacrylate, 2-ethylhexyl carbitol acrylate, 3-methoxy butyl acrylate, benzyl acrylate, cyclohexyl acrylate, isoamyl acrylate, isobutyl acrylate, methoxy triethylene glycol acrylate, phenoxy tetraethylene glycol acrylate, cetyl acrylate, isostearyl acrylate, stearyl acrylate, and a styrene monomer.

Specific examples of the radical polymerizable having two functional groups include, but are not limited to, 1,3-butane diol acrylate, 1,4-butane diol acrylate, 1,4-butane diol dimethacrylate, 1,6-hexane diol diacrylate, 1,6-hexane diol dimethaacrylate, diethylene glycol diacrylate, neopentyl glycol diacrylate, bisphenol A-EO modified diacrylate, bisphenol F-EO modified diacrylate, and neopentyl glycol diacrylate.

Specific examples of such functional monomers include, but are not limited to, a substitution product of, for example, octafluoro pentyl acrylate, 2-perfluoro octyl ethyl acrylate, 2-perfluoro octyl ethyl methacrylate, and 2-perfluoroisononyl ethyl acrylate, in which a fluorine atom is substituted; vinyl monomers, acrylates, and methacrtylates having a polysiloxane group having 20 to 70 siloxane repeating units disclosed in JP-H05-60503-B (JP-S62-156172-A) and JP-H06-45770-B (JP-S62-290768-A) such as acryloyl polydimethyl siloxane ethyl, methacryloyl polydimethyl siloxane ethyl, acryloyl polydimethyl siloxane propyl, acryloyl polydimethyl siloxane butyl, and diacryloyl polydimethyl siloxane diethyl.

Specific examples of the radical polymerizable oligomers include, but are not limited to, an epoxy acrylate based oligomer, a urethane acrylate based oligomer, and a polyester acrylate based oligomer.

In addition, when the cured resins mentioned above are used in the surface layer in the present disclosure, a polymerization initiator is optionally used to conduct the cross-linking reaction efficiently.

Specific examples of thermal polymerization initiators include, but are not limited to, a peroxide based initiator such as 2,5-dimethyl hexane-2,5-dihydroperoxide, dicumyl peroxide, benzoyl peroxide, t-butylcumyl peroxide, 2,5-dimethyl-2,5-di(peroxybenzoyl) hexine-3, di-t-butyl beroxide, t-butylhydro beroxide, cumenehydro beroxide, and lauroyl peroxide, and an azo based initiator such as azobis isobutyl nitrile, azobis cyalohexane carbonitrile, azobis iso methyl butyric acid, azobis isobutyl amidine hydrochloride, and 4,4′-azobis-4-cyano valeric acid.

Specific examples of photopolymerization initiators include, but are not limited to, an acetophenon based or ketal based photopolymerization initiators such as diethoxy acetophenone, 2,2-dimethoxy-1,2-diphenyl ethane-1-on, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-on, and 1-phenyl-1,2-propanedion-2-(o-ethoxycarbonyl)oxime; a benzoine ether based photopolymerization initiator such as benzoine, benzoine methyl ether, benzoine ethyl ether, benzoine isobutyl ether, and benzoine isopropyl ether; a benzophenone based photopolymerization initiator such as benzophenone, 4-hydroxy benzophenone, o-benzoyl methyl benzoate, 2-benzoyl naphthalene, 4-benzoyl biphenyl, 4-benzoyl phenyl ether, acrylizes benzophenone and 1,4-benzoyl benzene; a thioxanthone based photopolymerization initiator such as 2-isopropyl thioxanthone, 2-chlorothioxanthone, 2,4-dimethyl thioxanthone, 2,4-diethyl thioxanthone, and 2,4-dichloro thioxanthone; and other photopolymerization initiators such as ethyl anthraquinone, 2,4,6-trimethyl benzoyl diphenyl phosphine oxide, 2,4,6-trimethyl benzoyl phenyl ethoxy phosphine oxide, bis(2,4,6-trimethyl benzoyl)phenyl phosphine oxide, bis(2,4-dimethoxybenzoyl)-2,4,4-trimethyl pentyl phosphine oxide, a methylphenyl glyoxy ester, 9,10-phenanthrene, an acridine based compound, a triadine based compound, and an imidazole based compound.

In addition, a compound having an acceleration effect on photopolymerization can be used alone or in combination with the photopolymerization initiator. Specific examples of such compounds include, but are not limited to, triethanol amine, methyl diethanol amine, 4-dimethyl amino ethyl benzoate, 4-dimethyl amino isoamyl benzoate, ethyl benzoate (2-dimethyl amino), and 4,4′-dimethyl amino benzophenone.

These polymerization initiators can be used alone or in combination. The content of such a polymerization initiator is from 0.5 parts by weight to 40 parts by weight and preferably from 1 part by weight to 20 parts by weight based on 100 parts by weight to the total of the compound having a radical polymerization property.

Furthermore, the liquid application for use in forming the surface layer for use in the present invention optionally contains additives such as various kinds of plasticizers (for reducing internal stress or improving adhesiveness), a leveling agent, a low molecular weight charge transport material having no radical reactivity.

Known additives can be suitably used. A conventional resin such as dibutylphthalate and dioctyl phthalate can be used as such a plasticizer. The content thereof is not greater than 20% by weight and preferably not greater than 10% to the total solid portion of the liquid application.

Silicone oils such as dimethyl silicone oil and methyl phenyl silicone oil and a polymer or an oligomer having a perfluoroalkyl group in its side chain can be used as the leveling agent. The content thereof is suitably not greater than 3% by weight to the total solid portion of the liquid application. An excessively large amount of such an additive tends to inhibit curing, precipitate on the surface, or cause white turbidity of the film, which has a large negative impact on the durability to damage or abrasion resistance of a photoreceptor, so that it is suitable to use such an additive minimally

The surface layer is formed by applying and curing a liquid application containing radical polymerzable compounds, etc. When a liquid radical polymerizable monomer is used in the liquid application, other components are possibly dissolved in the liquid followed by application. Optionally, the liquid application is diluted by a suitable solvent before coating.

Specific examples of such solvents include, but are not limited to, alcohols such as methanol, ethanol, propanol, and butanol; ketones such as acetone, methyl ethyl ketone, methyl isobutyl ketone, and cycle hexanone; esters such as ethyl acetate and butyl acetate; ethers such as tetrahydrofuranm dioxane and propyl ether; halogen-based solvents such as dichloromethane, dichloroethane, trichloroethane, and chlorobenzene; aromatic series based solvents such as benzene, toluene, and xylene; and cellosolve based solvents such as methyl cellosolve, ethyl cellosove, and cellosolve acetate.

These solvents can be used alone or in combination.

The dilution ratio by using such a solvent is arbitrary and varies depending on the solubility of a composition, a coating method, and a target layer thickness. A dip coating method, a spray coating method, a bead coating method, a ring coating method, etc., is used to apply the liquid application.

If a solvent for diluting the liquid application that easily dissolves an underlayer (photosensitive layer, charge transport layer, charge generating layer, etc.) provided under the surface layer is used in a large amount, the component of the under layers such as the resin binder and the low molecular weight charge transport material mingles into the surface layer, which prevents curing reaction. In addition, the surface is not uniformly cured because the liquid application is just as if it contains a large amount of non-curing materials.

To the contrary, when a solvent for diluting the liquid application that never dissolves an underlayer is used, the attachability between the surface layer and the underlayer deteriorates, which results in forming a cratered surface layer due to volume contraction during curing reaction. For this reason, the surface roughness of the photoreceptor increases and the underlayer having a low elastic displacement ratio is locally exposed.

To solve this problem, there are solutions such as using a solvent mixture to control the solubility of the underlayer; reducing the amount of a solvent contained in the applied surface layer by adjusting the liquid composition or the application method; subduing mingling of the underlayer component by using a charge control agent, etc. into the under layer; and providing an intermediate layer which is little soluble or insoluble in the solvent or has good attachability between the surface layer and the underlayer.

In the present disclosure, it is preferable that the surface layer is formed by curing upon application of external energy such as heat, light, and radiation following application of the liquid application. Heat can be applied to the surface layer from the application surface side or the substrate side using a gas such as air or nitrogen, vapor, or various kinds of heat media, infra-red radiation, or electromagnetic wave. The heating temperature is not lower than 100° C. and preferably not higher than 170° C.

When the heating temperature is too low, the reaction speed tends to be slow so that the curing reaction does not complete. A heating temperature that is too high tends to cause non-uniform curing reaction, thereby significantly distorting the inside of the surface layer.

A method of heating the surface layer at a relatively low temperature, for example lower than 100° C., followed by heating at a relatively high temperature, for example, 100° C. or higher is suitable to uniformly proceed curing reaction.

As light energy, a UV irradiation light source such as a high pressure mercury lamp or a metal halide lamp having an emission wavelength mainly in the ultraviolet area is used. A visible light source can be selected according to the absorption wavelength of a radical polymerizable compound and a photopolymerization initiator.

The irradiation light amount is preferably from 50 mW/cm² to 1,000 mW/cm². When the irradiation light amount is too small, it takes a long time to complete the curing reaction.

An irradiation light amount that is too large tends to prevent a uniform curing reaction, which creates a rough surface layer. Beams of electron can be used as the radiation ray energy. Among these forms of energies, thermal or light energy is suitably used in terms of easiness of controlling the reaction speed and simplicity of the device.

Containing a bulky charge transport structure in the surface layer to maintain good electric characteristics and increasing the density of the cross linking bonding to improve the durability are suitable in the present disclosure.

If an extremely high energy is applied from outside to violently conduct the curing reaction of a surface layer after application of a liquid application, the curing reaction proceeds non-uniformly and the elastic displacement ratio varies greatly, thereby degrading the present disclosure. Therefore, using an eternal energy such as thermal energy or optical energy is preferable because the reaction speed can be controlled by the heating condition, the irradiation intensity condition, and the amount of the polymerization initiator.

A specific example of the method of preparing the surface layer of a photoreceptor is: for example, when an acrylate monomer having three acryloyloxy groups and a triaryl amine compound having an acryloyloxy group are used as the liquid application, a polymerization initiator is added to the acrylate compound with a ratio of 3% by weight to 10% by weight to the total amount of the acrylate compound and a solvent is added to prepare a liquid application.

For example, when a triaryl amine-based donor serving as a charge transport material and a polycarbonate serving as a binder resin are used in a charge transport layer provided under the surface layer and the surface layer is formed by a spray-coating method, it is preferable to use teterahydrofuran, 2-butanone, or ethyl acetate as the solvent for the liquid application. The content of the solvent is twice to 8 times as much as the total weight of the acrylate compound.

Next, for example, the liquid application prepared as described above is applied with, for example, a spray, on a photoreceptor formed by sequentially applying an undercoating layer, a charge generating layer, and a charge transport layer in this order on a substrate such as an aluminum cylinder. Subsequent to drying the liquid application at a relatively low temperature (25° C. to 80° C.) for a short time (1 to 10 minutes), the liquid application is cured upon application of UV ray irradiation or heat.

In the case of using UV ray irradiation, a metal halide lamp, etc., is used with a preferable illumination intensity of from 50 mW/cm² to 1,000 mW/cm². The surface is uniformly irradiated with UV light having an illumination intensity of, for example, 200 mW/cm² for about 20 seconds from multiple directions.

The drum temperature is controlled not to surpass 50° C. In the case of the heat curing, the heating temperature is preferably from 100° C. to 170° C. An air supply oven is used as a heating device. The liquid application is heated for 20 minutes to 3 hours when the heating temperature is set at 150° C.

Subsequent to completion of the curing reaction, the surface layer is heated at 100° C. to 150° C. for 10 minutes to 30 minutes to reduce the amount of remaining solvent to obtain the photoreceptor of the present disclosure.

When the surface layer forms the surface portion of a charge transport layer, as described in the surface layer forming method described above, a liquid application containing the radical polymerizable composition is applied to the underlayer of the charge transport layer followed by optional drying and thereafter the curing reaction starts by an external energy such as heat or light to form a surface layer.

The thickness of the surface layer is suitably from 1 μm to about 20 μm and preferably from 2 μm to 10 μm.

When the layer is too thin, the durability varies due to non-uniform thickness.

When the layer is too thick, the thickness of the entire charge transport layer becomes thick, thereby causing charge diffusion, which leads to degradation of the image reproducibility.

In the present disclosure, it is possible to contain a filler in the surface layer. Such fillers cause the surface layer suitably concavo-convex, which is expected to improve the cleanability.

Inorganic fillers and organic fillers can be suitably used for the surface layer but inorganic fillers are more preferable.

Specific examples of the organic fillers include, but are not limited to, powders of fluorine-containing resins such as polytetrafluoroethylene, silicone resin powders, and a-carbon powders.

Specific examples of the inorganic fillers include, but are not limited to, metal oxides such as silica, tin oxide, zinc oxide, titanium oxide, alumina, zirconium oxide, indium oxide, antimony oxide, bismuth oxide, calcium oxide, tin oxide doped with antimony, indium oxide doped with tin, fluorinated metals such as fluorinated tin, fluorinated calcium, and fluorinated aluminum, potassium titanate, and arsenic nitride. These fillers can be used alone or in combination.

To improve the dispersability, surface treated fillers are also usable.

These fillers are dispersed in a liquid application for a surface layer by a known device such as a ball mill and a sand mill.

The content of the filler is preferably from 5% by weight to 40% by weight and more preferably from 10% by weight to 30% by weight to the total solid portion in terms of the electrostatic properties.

The-thus-formed roughness of the surface of a photoreceptor by the filler contained in the cross-linking resin changes little from the initial even when the surface of the photoreceptor is abraded during long-term usage. Therefore, a lubricant, which is described later is stably applied to this photoreceptor.

Next, the electroconductive substrate is described.

The electroconductive substrate can be formed by using a material having a volume resistance of not greater than 10¹⁰ Ω·cm.

For example, there can be used plastic or paper having a film form or cylindrical form covered with metal such as aluminum, nickel, chrome, nichrome, copper, gold, silver, and platinum, or a metal oxide such as tin oxide and indium oxide by depositing or sputtering. Also a board formed of aluminum, an aluminum alloy, nickel, and a stainless metal can be used.

Furthermore, a tube which is manufactured from the board mentioned above by a crafting technique such as extruding and extracting and surface-treatment such as cutting, super finishing and grinding is also usable.

In addition, an endless nickel belt and an endless stainless belt described in JP-S52-36016-A can be used as the electroconductive substrate.

An electroconductive substrate formed by applying to the substrate mentioned above a liquid application in which electroconductive powder is dispersed in a suitable binder resin can be used as the electroconductive substrate for use in the present disclosure.

Specific examples of such electroconductive powder include, but are not limited to, carbon black, acetylene black, metal powder, such as powder of aluminum, nickel, iron, nichrome, copper, zinc and silver, and metal oxide powder, such as electroconductive tin oxide powder and ITO powder. Specific examples of the binder resins which are used in combination with the electroconductive powder include, but are not limited to, thermoplastic resins, thermosetting resins, and optical curing resins, such as a polystyrene, a styrene-acrylonitrile copolymer, a styrene-butadiene copolymer, a styrene-anhydride maleic acid copolymer, a polyester, a polyvinyl chloride, a vinyl chloride-vinyl acetate copolymer, a polyvinyl acetate, a polyvinylidene chloride, a polyarylate (PAR) resin, a phenoxy resin, polycarbonate, a cellulose acetate resin, an ethyl cellulose resin, a polyvinyl butyral, a polyvinyl formal, a polyvinyl toluene, a poly-N-vinyl carbazole, an acrylic resin, a silicone resin, an epoxy resin, a melamine resin, an urethane resin, a phenolic resin, and an alkyd resin.

Such an electroconductive layer can be formed by dispersing the electroconductive powder and the binder resins mentioned above in a suitable solvent, for example, tetrahydrofuran (THF), dichloromethane (MDC), methyl ethyl ketone (MEK), and toluene and applying the resultant liquid dispersion to an electroconductive substrate.

In addition, an electroconductive substrate formed by providing a heat contraction tube as an electroconductive layer on a suitable cylindrical substrate can be used as the electroconductive substrate in the present disclosure.

The heat contraction tube is formed of material such as polyvinyl chloride, polypropylene, polyester, polystyrene, polyvinylidene chloride, polyethylene, chloride rubber, and TEFLON™, which includes the electroconductive powder mentioned above.

Next, the photosensitive layer is described. The photosensitive layer can employ a single layer structure or a laminate structure. A structure of the charge generating layer and the charge transport layer is described first for convenience.

The charge generating layer is mainly composed of a charge generating material. Any known charge generating material can be used in the charge generating layer. Specific examples thereof include, but are not limited to, monoazo pigments, disazo pigments, trisazo pigments, perylene-based pigments, perinone-based pigments, quinacridone-based pigments, quianone-based condensed polycyclic compounds, squalic acid-based dyes, other phthalocyanine-based pigments, naphthalocyanine-based pigments, and azulenium salt-based dyes.

These charge generating materials can be used alone or in combination.

The charge generating layer can be formed by dispersing a charge generating material and an optional binder resin in a suitable solvent using a ball mill, an attritor, a sand mill, or ultrasonic and applying the liquid dispersion to the electroconductive substrate followed by drying.

Specific examples of the binder resin optionally used in the charge generating layer include, but are not limited to, polyamides, polyurethanes, epoxy resins, polyketones, polycarbonates, silicone resins, acrylic resins, polyvinylbutyrals, polyvinylformals, polyvinylketones, polystyrenes, polysulfone, poly-N-vinylcarbazoles, polyacrylamides, polyvinyl benzale, polyester, phenoxy resin, copolymer of vinylchloride and vinyl acetate, polyvinyl acetate, polyphenylene oxide, polyamide, polyvinylpyridine, cellulose-based resin, casein, polyvinyl alcohol, and polyvinyl pyrolidone.

The content of the binder resin is from 0 parts by weight to 500 parts by weight and preferably from 10 parts by weight to 300 parts by weight to 100 parts by weight of the charge generating material. The binder resin can be added before or after dispersion of the charge generating material.

Specific examples of the solvents include, but are not limited to, isopropanol, acetone, methylethylketone, cyclohexanone, tetrahydrofuran, dioxane, ethylcellosolve, ethyl acetate, methylacetate, dichloromethane, dichloroethane, monochlorobenzene, cyclohexane, toluene, xylene, and ligroin. Among these, ketone-based solvents, ester-based solvents, and ether-based solvents are preferably used. These can be used alone or as a mixture of two or more.

The liquid application of the charge generating layer is mainly composed of a charge generating material, a solvent, and a binder resin and also optionally contains any additives such as a sensitizer, a dispersion agent, a surfactant, and silicone oil.

Known methods such as a dip coating method, a spray coating method, a bead coating method, a nozzle coating method, a spinner coating method, and a ring coating method can be used as the application method of the liquid application.

The thickness of the charge generating layer is suitably from about 0.01 μm to about 5 μm and preferably from 0.1 μm to 2 μm.

The charge transport layer is formed by dissolving and/or dispersing a charge transport material and a binder resin in a suitable solvent and applying the resultant liquid dispersion to the charge generating layer followed by drying.

In addition, a plasticizing agent, a leveling agent, an anti-oxidizing agent, etc. can be added, if desired. These can be used alone or in combination.

The charge transport material is typified into a hole transport material and an electron transport material.

Specific examples of such electron transport material include, but are not limited to, electron acceptance materials such as chloranil, bromanil, tetracyano ethylene, tetracyanoquino dimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothhiophene-5,5-dioxide, and benzoquinone derivatives.

Specific examples of the hole transport materials include, but are not limited to, poly-N-vinylvarbazole) and derivatives thereof, poly-γ-carbzoyl ethylglutamate) and derivatives thereof, pyrenne-formaldehyde condensation products and derivatives thereof, polyvinylpyrene, polyvinyl phnanthrene, polysilane, oxazole derivatives, oxadiazole derivatives, imidazole derivatives, monoaryl amine derivatives, diaryl amine derivatives, triaryl amine derivatives, stilbene derivatives, α-phenyl stilbene derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, bisstilbene derivatives, enamine derivatives, and other known materials. These charge transport materials may be used alone or in combination.

Specific examples of the binder resin include, but are not limited to, thermoplastic resins or thermocuring resins, for example, polystyrene, copolymers of styrene and acrylonitrile, copolymers of styrene and butadiene, copolymers of styrene and maleic anhydrate, polyesters, polyvinyl chlorides, copolymers of a vinyl chloride and a vinyl acetate, polyvinyl acetates, polyvinylidene chloride, polyarylate resins, phenoxy resins, polycarbonate reins, cellulose acetate resins, ethyl cellulose resins, polyvinyl butyral, polyvinyl formal, polyvinyl toluene, poly-N-vinylcarbozole, acrylic resin, silicone resins, epoxy resins, melamine resins, urethane resins, phenolic resins, and alkyd resins.

The content of the charge transport material is from 20 parts by weight to 300 parts by weight and preferably from 40 parts by weight to 150 parts by weight to 100 parts by weight of the binder resin. The thickness of the charge transport layer is preferably 25 μm or less in terms of the resolution and responsiveness.

Although depending on the property (charging voltage in particular) of the system used, the lower limit is preferably 5 μm or more.

Specific examples of the solvent for use in the liquid application for the charge transport layer include, but are not limited to, tetrahydrofuran, dioxane, toluene, dichloromethane, monochlorobenzene, dichloroethane, cyclohexanone, methylethylketone, and acetone. These solvents can be used alone or in combination.

The present disclosure is applicable to a photoreceptor having a photosensitive layer having a single layer structure.

Any photoreceptor in which the charge generating material described above is dispersed in a binder resin can be used.

The photsensitive layer can be formed by dissolving or dispersing these charge transport materials and the binder resins in a suitable solvent followed by coating and drying. In addition, a plasticizing agent, a leveling agent, an anti-oxidizing agent, etc. can be added, if desired.

In addition to the binder resin specified for the charge transport layer, the binder resin specified for the charge generating layer can be mixed for use.

The charge transport polymer specified above can be also used. The content of the charge generating material is preferably from 5 parts by weight to 40 parts by weight and the content of the charge transport material is preferably from 0 parts by weight to 190 parts by weight and more preferably from 50 parts by weight to 150 parts by weight to 100 parts by weight of the binder resin.

The photosensitive layer can be formed by applying a liquid application in which the charge generating material, the binder resin, and the charge transport material are dispersed in a solvent such as tetrahydrofuran, dioxane, dichloroethane, or cyclohexane by a dispersing machine using a dip coating method, a spray coating method, a bead coating method, and a ring coating method.

The thickness of the photosensitive layer is suitably from about 5 μm to about 25 μm.

In the photoreceptor of the present disclosure, an undercoating layer can be provided between the electroconductive substrate and the photosensitive layer.

Typically, such an undercoating layer is mainly made of a resin. Considering that a photosensitive layer is formed thereon in a form of solvent, the resin is preferably not or little soluble in known organic solvents.

Specific examples of such resins include, but are not limited to, water soluble resins, such as polyvinyl alcohol, casein, and sodium polyacrylate, alcohol soluble resins, such as copolymerized nylon and methoxymethylized nylon and curing resins which form a three dimension mesh structure, such as polyurethane, melamine resins, phenolic resins, alkyd-melamine resins, and epoxy resins. In addition, fine powder pigments of a metal oxide, such as titanium oxides, silica, alumina, zirconium oxides, tin oxides, and indium oxides can be added to the undercoating layer to prevent moiré and reduce the residual voltage.

The undercoating layer described above can be formed by using a suitable solvent and a suitable coating method as described for the photosensitive layer.

Silane coupling agents, titanium coupling agents, and chromium coupling agents can be used in the undercoating layer. Furthermore, the undercoating layer can be formed by using a material formed by anodizing Al₂O₃, or an organic compound, such as polyparaxylylene (parylene) or an inorganic compound, such as SiO₂, SnO₂, TiO₂, ITO, and CeO₂ by a vacuum thin-film forming method. Any other known methods can be also used.

The thickness of the undercoating layer is suitably from 0 μm to 5 μm.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Examples 1 to 3

### Manufacturing of Photoreceptor

A liquid application of an undercoating layer having the following recipe, a liquid application of a charge generating layer having the following recipe, and a liquid application of a charge transport layer having the following recipe were applied to an aluminum cylinder having an outer diameter of 40 mm in this order and dried to form an undercoating layer having a thickness of about 3.5 μm, a charge generating layer having a thickness of about 0.2 μm, and a charge transport layer having a thickness of about 18 μm.

A liquid application of a surface layer having the following recipe was applied to the charge transport layer by a spray coating followed by irradiation by a metal halide lamp of 160 W/cm with an irradiation intensity of 200 mW/cm² for 20 seconds, and dried at 130° C. for 20 minutes to obtain a surface layer having a thickness of 4 μm.

A photoreceptor was thus obtained.

Liquid Application of Undercoating Layer

| | |
|---|---|
| Alkyd resin (Beckozole 1307-60-EL, manufactured by | 6 parts |
| Dainippon Ink and Chemicals, Inc.) | |
| Melamine resin (Super-beckamine G-821-60, manufactured | 4 parts |
| by Dainippon Ink and Chemicals, Inc.) | |
| Titanium oxide: | 40 parts |
| Methylethylketone: | 50 parts |

Liquid Application of Charge Generating Layer

| | | |
|---|---|---|
| Bisazo pigment represented by the following chemical formula A: | 2.5 | parts |
| Polyvinyl butyral {XYHL, manufactured by Union Carbide Corporation (UCC)} | 0.5 | parts |
| Cyclohexanone: | 200 | parts |
| Methylethylketone: | 80 | parts |

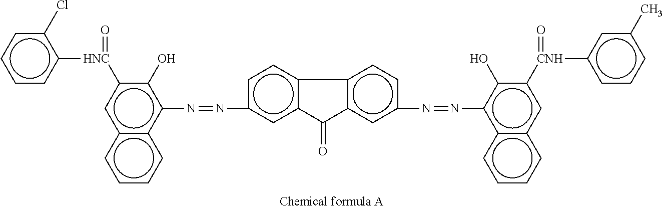

Liquid Application of Charge Transport Layer

| | | |
|---|---|---|
| Bisphenol Z polycarbonate: (Panlite TS-2050, manufactured | 10 | parts |
| by TEIJIN CHEMICALS LTD.) | | |
| Low molecular weight charge transport material represented | 7 | parts |
| by the following Chemical formula B | | |
| Tetrahydrofuran: | 100 | parts |
| Tetrahydrofuran solution of 1% silicone oil: (KF-50-100CS, | 1 | part |
| manufactured by Shin-Etsu Chemical Co., Ltd.) | | |

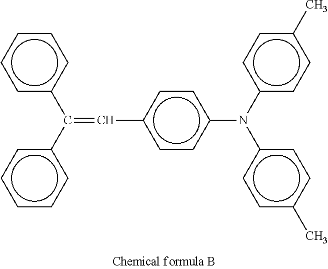

Liquid Application of Surface Layer

| | |
|---|---|
| Radical polymerizable monomer having three or more | 10 parts |
| functional groups with no charge transport structure: | |
| Trimethylol propane triacrylate: (KAYARAD TMPTA, | |
| manufactured by Nippon Kayaku Corporation, Molecular | |
| weight: 296; Number of functional groups: three; | |
| Molecular weight/number of functional groups = 99) | |
| Radical polymerizable compound having one functional | 10 parts |
| group with a charge transport structure: (Illustrated | |
| Compound No. 54) | |
| Photo polymerization initiator: 1-hydroxy-cyclohexyl- | 1 part |
| phenyl-ketone (IRGACURE 184, manufactured by Chiba | |
| Specialty Chemicals)} | |
| Tetrahydrofuran: | 100 parts |

### Example 4

### Containing Radical Polymerizable Monomer Having Three or More Functional Groups and Filler

A photoreceptor of Example 4 was manufactured in the same manner as in Examples 1 to 3 except that 5 parts of alumina particulates (AA03, manufactured by Sumitomo Chemical Co., Ltd.) was added to the liquid application of the surface layer as a filler.

### Example 5

### Containing Radical Polymerizable Monomer Having Three or More Functional Groups with Molecular Weight/Number of Functional Groups=211

A photoreceptor of Example 5 was manufactured in the same manner as in Examples 1 to 3 except that the liquid application of the cross linked surface layer was replaced with a liquid application having the following recipe:

Liquid Application of Surface Layer

| | |
|---|---|
| Radical polymerizable monomer having no charge | 10 parts |
| transport structure: Caprolactone modified | |
| dipentaerythritol hexaacrylate: (KAYARAD DPCA-60, | |
| manufactured by Nippon Kayaku Corporation, | |
| Molecular weight: 1,263, Number of functional | |
| groups: 6, Molecular weight/number of functional | |
| groups = 211) | |

### Example 6

### Containing Radical Polymerizable Monomer Having Three or More Functional Groups with Molecular Weight/Number of Functional Groups=325

A photoreceptor of Example 6 was manufactured in the same manner as in Examples 1 to 3 except that the radical polymerizable monomer having three or more functional groups without a charge transport structure contained in the liquid application of surface layer was replaced with the following monomer. The thickness of the layer was 4.0 μm.

| | |
|---|---|
| Radical polymerizable monomer having three or more | 10 parts |
| functional groups with no charge transport structure: | |
| Caprolactone modified dipentaerythritol hexaacrylate | |
| (KAYARAD DPCA-120, manufactured by Nippon Kayaku | |
| Corporation, Molecular weight: 1,947, Number of | |
| functional groups: 6, Molecular weight/number of | |
| functional groups = 325) | |

### Example 7

### Containing Radical Polymerizable Monomer Having Three or More Functional Groups Changed to Two Functional Groups

A photoreceptor of Example 7 was manufactured in the same manner as in Examples 1 to 3 except that the radical polymerizable monomer having three or more functional groups without a charge transport structure contained in the liquid application of surface layer was replaced with 10 parts of the following radical polymerizable monomer having two functional groups without a charge transport structure:

| | |
|---|---|
| Radical polymerizable monomer having two functional | 10 parts |
| groups with no charge transport structure: 1.6-hexane | |
| diol diacrylate (manufactured by Wako Pure Chemical | |
| Industries, Ltd., Molecular weight: 226, Number of | |
| functional groups: 2, Molecular weight/number of | |
| functional groups = 113): | |

### Example 8

### Radical Polymerizable Compound Having One Functional Group Changed to Two Functional Groups

A photoreceptor of Example 8 was manufactured in the same manner as in Examples 1 to 3 except that the radical polymerizable compound was replaced with 10 parts of the following radical polymerizable compound having two functional groups with a charge transport structure represented by Chemical formula 6.

| | |
|---|---|
| Radical polymerizable compound having two functional groups | 10 parts |
| with a charge transport structure | |

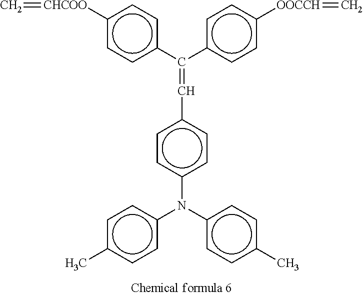

### Comparative Example

### No Liquid Application of Surface Layer

A photoreceptor of Comparative Example 1 was manufactured in the same manner as in Examples 1 to 3 except that no cross-linked surface layer was prepared and the thickness of the charge transport layer was changed to 25 μm.

### Comparative Example 2

### Surface Layer (Polycarbonate Layer)

A photoreceptor of Comparative Example 2 was manufactured in the same manner as in Examples 1 to 3 except that the liquid application of the surface layer was replaced with the liquid application of the surface layer having the following recipe:

Liquid Application of Surface Layer

| | |
|---|---|
| Low molecular weight charge transport material for use | 2 parts |
| in the liquid application of the charge transport layer: | |
| Bisphenol Z type polycarbonate: | 2 parts |
| Tetrahydrofuran: | 70 parts |
| Cyclohexanone: | 25 parts |

### Comparative Example 3

### Surface Layer (Polycarbonate Layer)+Filler Liquid Application of Surface Layer

A photoreceptor of Comparative Example 3 was manufactured in the same manner as in Examples 1 to 3 except that the liquid application of the surface layer was replaced with the liquid application of the surface layer having the following recipe:

| | |
|---|---|
| Low molecular weight charge transport material for use | 2 parts |
| in the liquid application of the charge transport layer: | |
| Bisphenol Z type polycarbonate: | 2 parts |
| Aluminum particulates (AA03, manufactured by Sumitomo | 5 parts |
| Chemical Co., Ltd.) | |
| Tetrahydrofuran: | 70 parts |
| Cyclohexanone: | 25 parts |

### Comparative Example 4

### Surface Layer (Polyarylate Layer)

A photoreceptor of Comparative Example 4 was manufactured in the same manner as in Examples 1 to 3 except that the liquid application of the surface layer was changed to the following recipe.

Liquid Application of Surface Layer

| | |
|---|---|
| Low molecular weight charge transport material for use | 2 parts |
| in the liquid application of the charge transport layer: | |
| Polyarylate (U polymer U-100, manufactured by | |
| UNITIKA LTD.) | |
| Tetrahydrofuran: | 70 parts |
| Cyclohexanone: | 25 parts |

### Comparative Example 5

### Containing No Radical Polymerizable Monomer Having Three or More Functional Groups

A photoreceptor of Comparative Example 5 was manufactured in the same manner as in Examples 1 to 3 except that no radical polymerizable monomer having three or more functional groups without a charge transport structure was contained in the liquid application of surface layer and the content of the radical polymerizable compound having a charge transport structure was changed to 18 parts.

Liquid Application of Surface Layer

| | |
|---|---|
| Radical polymerizable monomer having three or more | 0 parts |
| functional groups with no charge transport structure: | |
| Radical polymerizable monomer having a charge | 18 parts |
| transport structure: | |
| Illustrated Compound No. 54 | |
| Photo polymerization initiator: (1-hydroxy-cyclohexyl- | 1 part |
| phenyl-ketone (IRGACURE 184, manufactured by Chiba | |
| Specialty Chemicals, Ltd.)} | |
| Tetrahydrofuran: | 100 parts |

### Comparative Example 6

### Containing No Radical Polymerizable Compound

A photoreceptor of Comparative Example 6 was manufactured in the same manner as in Examples 1 to 3 except that no radical polymerizable compound having a charge transport structure was contained in the liquid application of surface layer and the content of the radical polymerizable monomer having three or more functional groups without a charge transport structure was changed to 18 parts.

Liquid Application of Surface Layer

| | |
|---|---|
| Radical polymerizable monomer having three or more | 18 parts |
| functional groups with no charge transport structure: | |
| Radical polymerizable compound having no charge | 0 parts |
| transport structure: | |
| Illustrated Compound No. 54 | |
| Photo polymerization initiator: (1-hydroxy-cyclohexyl- | 1 part |
| phenyl-ketone (IRGACURE 184, manufactured by Chiba | |
| Specialty Chemicals, Ltd.)} | |
| Tetrahydrofuran | 100 parts |

EP70 (manufactured by Inoac Corporation) was used as the foam roller in Example 1.
RMM50 (manufactured by Inoac Corporation) was used as the foam roller in Example 2.
HR50 (manufactured by Bridgestone Diversified Chemical Products Co., Ltd.) was used as the foam roller in Example 3.
EP70 (manufactured by Inoac Corporation) was used as the foam roller in Examples 4 to 8 and Comparative Examples 1 to 6.

All the rollers had a shaft (core material) diameter of 6 mm and a urethane layer having a thickness of 3 mm.

The comparison conditions are as follows:

The protective agent in Examples was manufactured by compressive-molding a powder mixture of zinc stearate (aliphatic acid metal salt) and boron nitride (inorganic lubricant) as illustrated in FIGS. A, B, C, and D.

The blending ratio of boron nitride was 10% by weight based on the entire of the protective agent.

Zinc stearate: GF-200, manufactured by NOF CORPORATION
Boron nitride: NX10, manufactured by Momentive Performance Materials Inc.

Respective foam rollers serving as the protective agent supplying member 22 illustrated in FIG. 2 were provided in the imaging unit of imagio MP C5000, manufactured by RICOH Co., Ltd.

In addition, in FIG. 2, respective photoreceptors were arranged as the image bearing member (drum photoreceptor) 1 of FIG. 2.

After assembling respective photoreceptors and foam rollers, these were left at 45° C. and 50% for 5 days in a constant temperature and moisture tank.

Thereafter, the set of the photoreceptor and the foam roller was set in the black station of imagio MP C5000 and a solid image was output on the entire of A3 sheet with a run length of 10 sheets.

The output images were evaluated on whether white spots were observed on the images.

The evaluation results based on the conditions described above are shown in Table 2.

TABLE 2

| | | | Radical | | | | |
|---|---|---|---|---|---|---|---|
| | | | Polymerizable | Radical | Polymerizable | | |
| | | | monomer having | polymerrizable | monomer molecular | | |
| | | Surface | three or more | compound having | weight/number of | | White |
| | Surface | layer | functional | a functional | functional | | spot |
| | layer | filler | groups | group | groups | Roller | evaluation |
| Example 1 | Yes | No | Yes | Yes | 99 | RMM | G |
| Example 2 | Yes | No | Yes | Yes | 99 | HR50 | G |
| Example 3 | Yes | No | Yes | Yes | 99 | EPT | G |
| | | | | | | 51 | |
| Example 4 | Yes | Alumina | Yes | Yes | 99 | RMM | G |
| Example 5 | Yes | No | Yes | Yes | 211 | RMM | G |
| Example 6 | Yes | No | Yes | Yes | 325 | RMM | F |
| Example 7 | Yes | No | Two | Yes | 99 | RMM | F |
| | | | functional | | | | |
| | | | groups | | | | |
| Example 8 | Yes | No | Yes | Two | 99 | RMM | F |
| | | | | functional | | | |
| | | | | groups | | | |
| Comparative | No | No | No | No | — | RMM | B |
| Example 1 | | | | | | | |
| Comparative | Polycarbonate | No | No | No | — | RMM | B |
| Example 2 | | | | | | | |
| Comparative | Polycarbonate | Alumina | No | No | — | RMM | B |
| Example 3 | | | | | | | |
| Comparative | Polyarylate | No | No | No | — | RMM | B |
| Example 4 | | | | | | | |
| Comparative | Yes | No | No | Yes | — | RMM | B |
| Example 5 | | | | | | | |
| Comparative | Yes | No | Yes | No | 99 | RMM | B |
| Example 6 | | | | | | | |

Evaluation Criteria (Observation of White Spot by Naked Eyes)
G (Good): No white spot observed
F (Fair): White spots observed slightly, but causing no practical problem
B (Bad): White spot observed

| Lubricant manufacturing method | Lubricant prescription |
|---|---|
| Compression | ZnSt + BN |

As seen in Table 2, in Examples, the durability against mechanical stress and in particular chemical attack (contamination resistance) was improved by the surface of the each photoreceptor having a three-dimensional cross-linking structure even in the case in which the protective agent was supplied from the protective agent supplying member containing a foam.

Furthermore, the impact on the surface layer can be subdued even when the supplied protective agent is gasified and hydrolyzed. As described above, according to the present invention, the surface of the image bearing member has a three-dimensional cross-linking structure, thereby significantly increasing the durability against both mechanical stress and chemical attack (contamination resistance). As a result, the surface of the image bearing member is not contaminated by contact with any foam layer while subduing the change of the surface, which makes it possible to continue printing quality images even if a roller having a foam layer contacts the image bearing member for a long time or is used in a difficult environment.

Moreover, according to the present disclosure, an image forming apparatus is provided which is capable of printing quality images for an extended period of time by having the protective agent supplying member having a roller-like form including the foam layer which prevents contamination even when contaminants such as catalysts and foam stabilizers from the foam layer bleed.

Having now fully described embodiments of the present invention, it will be apparent to one of ordinary skill in the art that many changes and modifications can be made thereto without departing from the spirit and scope of embodiments of the invention as set forth herein.

What is claimed is:

1. An image bearing member comprising:
a substrate; and
a photosensitive layer overlying the substrate; and
a surface layer overlying photosensitive layer,
wherein the surface layer comprises a cross-linked layer formed by curing a radical polymerizable monomer having no charge transport structure and a radical polymerizable compound having a charge transport structure,
wherein a protective agent is supplied to the surface layer by a protective agent supplying member which is arranged facing the surface layer and comprises a roller having a core material and a foam layer thereon to form a protective layer on the surface layer.

2. An image forming apparatus comprising:
an image bearing member to bear a toner image, which has a surface layer comprising a cross-linked layer formed by curing a radical polymerizable monomer having no charge transport structure and a radical polymerizable compound having a charge transport structure; and
a protective agent supplying member to apply or attach a protective agent to the surface layer of the image bearing member, which comprises a roller having a core material and a foam layer thereon.

3. The image forming apparatus according to claim 2, wherein the foam layer comprises a urethane foam.

4. The image forming apparatus according to claim 2, wherein the foam layer is an interconnected cell type.

5. The image forming apparatus according to claim 2, wherein the radical polymerizable monomer having no charge transport structure has three or more functional groups and the radical polymerizable compound having a charge transport structure has a single functional group.

6. The image forming apparatus according to claim 5, wherein, a ratio of a molecular weight to a number of functional group in the radical polymerizable monomer having no charge transport structure is 250 or less.

7. The image forming apparatus according to claim 5, wherein the three or more functional groups of the radical polymerizable monomer having no charge transport structure are acryloyloxy groups and/or methcryloyloxy groups.

8. The image forming apparatus according to claim 5, wherein the single functional group of the radical polymerizable compound having a charge transport structure is an acryloyloxy group or a methcryloyloxy group.

9. The image forming apparatus according to claim 5, wherein the charge transport structure of the radical polymerizable compound having a charge transport structure is a triaryl amine structure.

10. The image forming apparatus according to claim 5, wherein the radical polymerizable compound having a charge transport structure is at least one compound represented by Chemical structure 1 or Chemical structure 2: 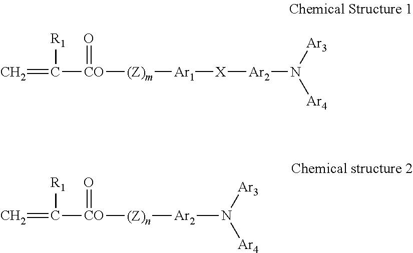
In the Chemical structures 1 and 2, R₁ represents a hydrogen atom, a halogen atom, a substituted or non-substituted alkyl group, a substituted or non-substituted aralky group, a substituted or non-substituted aryl group, a cyano group, a nitro group, an alkoxy group, —COOR11 (where R11 represents a hydrogen atom, a substituted or non-substituted alkyl group, a substituted or non-substituted aralkyl group, or a substituted or non-substituted aryl group), a halogenated carbonyl group, or CONR12R13, (where R12 and R13 independently represent hydrogen atoms, halogen atoms, substituted or non-substituted alkyl groups, substituted or non-substituted aralkyl groups, or substituted or non-substituted aryl groups, and Ar₁ and Ar₂ independently represent substituted or non-substituted arylene groups, Ar₃ and Ar₄ independently represent substituted or non-substituted aryl groups, X represents a single bond, a substituted or non-substituted alkylene group, a substituted or non-substituted cycloalkylene group, a substituted or non-substituted alkylene ether group, an oxygen atom, a sulfur atom, or a vinylene group, Z represents a substituted or non-substituted alkylene group, a substituted or non-substituted alkylene ether group, or a substituted or non-substituted alkyleneoxy carbonyl group, and m and n independently represent integers of from 0 to 3.

11. The image forming apparatus according to claim 4, wherein the radical polymerizable compound having a charge transport structure is at least one compound represented by Chemical structure 3: 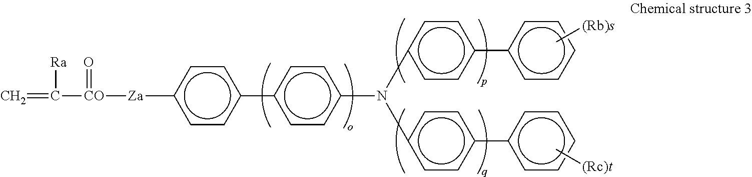
In the Chemical structures 3 and 4, “o”, “p”, “q”, each, independently, represent 0 or 1, s and t, each, independently, represent 0 or an integer of from 1 to 3, Ra represents a hydrogen atom or a methyl group, Rb and Rc, each, independently, represent an alkyl group having 1 to 6 carbon atoms, and Za represents a single bond, a methylene group, an ethylene group, —CH₂CH₂O—, CH₃CHCH₂O—, or C₆H₅CH₂CH₂—.
